(19) United States
(12) Patent Application Publication
(10) Pub. No.: US 2025/0024297 A1
(43) Pub. Date: Jan. 16, 2025

(54) METHOD AND APPARATUS OF HANDLING QUALITY OF EXPERIENCE REPORT AND CONFIGURATION IN SECONDARY CELL GROUP RELEASE OR DEACTIVATION IN NEXT MOBILE COMMUNICATION SYSTEM

(71) Applicant: Samsung Electronics Co., Ltd., Gyeonggi-do (KR)

(72) Inventors: Sangyeob JUNG, Gyeonggi-do (KR); Seungbeom JEONG, Gyeonggi-do (KR)

(21) Appl. No.: 18/767,353

(22) Filed: Jul. 9, 2024

(30) Foreign Application Priority Data
Jul. 10, 2023 (KR) 10-2023-0089107

(51) Int. Cl. H04W 24/10; H04L 41/5067; H04W 80/12

(52) U.S. Cl. CPC H04W 24/10; H04L 41/5067; H04W 80/12

(57) ABSTRACT

A method performed by a user equipment (UE) supporting a master cell group (MCG) and a secondary cell group (SCG) includes receiving at least one application layer measurement configuration information included in first radio resource control (RRC) reconfiguration information for the MCG or in second RRC reconfiguration information for the SCG, transmitting a report message for an application layer measurement report based on the configuration information, receiving a second RRC reconfiguration message for releasing the SCG, informing, for first application layer measurement configuration information included in the second RRC reconfiguration information, an upper layer about release of first application layer measurement configuration information, and discarding a first application layer measurement report associated with the first application layer measurement configuration information that is not yet fully submitted to a lower layer for transmission.

### CROSS REFERENCE TO RELATED APPLICATION

The present application claims priority under 35 U.S.C. § 119 to Korean Patent Application No. 10-2023-0089107, which was filed in the Korean Intellectual Property Office on Jul. 10, 2023, the entire content of which is incorporated herein by reference.

### BACKGROUND

### 1. Field

The disclosure relates generally to a mobile communication system terminal and base station, and more particularly, to a method and apparatus for handling quality of experience (QoE) when a terminal releases or deactivates a secondary cell group (SCG) in a mobile communication system.

### 2. Description of Related Art

Fifth generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) bands including 28 GHz and 39 GHz. In addition, it has been considered to implement sixth generation (6G) mobile communication technologies referred to as beyond 5G systems in terahertz (THz) bands such as 95 GHz to 3 THz bands to realize transmission rates fifty times faster than 5G mobile communication technologies and ultra-low latencies one-tenth of 5G mobile communication technologies.

Since the initial development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

There are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for simplifying random access procedures for NR. There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum, and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure has been made to address at least the above-mentioned problems and/or disadvantages and to provide at least the advantages described below.

Accordingly, an aspect of the disclosure is to provide an improved QoE measurement and reporting method in case of releasing or deactivating an SCG.

In accordance with an aspect of the disclosure, a method performed by a UE supporting a master cell group (MCG) and a secondary cell group (SCG) in a wireless communication system includes receiving at least one application layer measurement configuration information included in a first radio resource control (RRC) reconfiguration information for the MCG or included in a second RRC reconfiguration information for the SCG, based on the at least one application layer measurement configuration information, transmitting a report message for an application layer measurement report, receiving a second RRC reconfiguration message for releasing the SCG, informing, for first application layer measurement configuration information included in the second RRC reconfiguration information for the SCG, an upper layer about a release of the first application layer measurement configuration information, and discarding a first application layer measurement report associated with the first application layer measurement configuration information that is not yet fully submitted to a lower layer for a transmission.

In accordance with an aspect of the disclosure, a method performed by an MCG in a wireless communication system includes transmitting, to a UE, at least one application layer measurement configuration information included in a first RRC reconfiguration information for the MCG or included in a second RRC reconfiguration information for an SCG and transmitting, to the UE, a second RRC reconfiguration message for releasing the SCG, wherein for first application layer measurement configuration information included in the second RRC reconfiguration information for the SCG, a release of the first application layer measurement configuration information is informed to an upper layer, and wherein a first application layer measurement report associated with the first application layer measurement configuration information which is not yet fully submitted to a lower layer for a transmission is discarded.

In accordance with an aspect of the disclosure, a UE supporting an MCG and an SCG in a wireless communication system includes a transceiver, and a controller configured to receive at least one application layer measurement configuration information included in a first radio resource control (RRC) reconfiguration information for the MCG or included in a second RRC reconfiguration information for the SCG, based on the at least one application layer measurement configuration information, transmit a report message for an application layer measurement report, receive a second RRC reconfiguration message for releasing the SCG, informing, for first application layer measurement configuration information included in the second RRC reconfiguration information for the SCG, an upper layer about a release of the first application layer measurement configuration information, and discarding a first application layer measurement report associated with the first application layer measurement configuration information which is not yet fully submitted to a lower layer for a transmission.

In accordance with an aspect of the disclosure, a base station associated with an MCG in a wireless communication system includes a transceiver, and a controller configured to transmit, to a user equipment, at least one application layer measurement configuration information included in a first RRC reconfiguration information for the MCG or included in a second RRC reconfiguration information for an SCG, and transmit, to the UE, a second RRC reconfiguration message for releasing the SCG, wherein for first application layer measurement configuration information included in the second RRC reconfiguration information for the SCG, a release of the first application layer measurement configuration information is informed to an upper layer, and wherein a first application layer measurement report associated with the first application layer measurement configuration information which is not yet fully submitted to a lower layer for a transmission is discarded.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a long term evolution (LTE) system to which the disclosure is applicable;

FIG. 2 illustrates a structure of a wireless protocol in an LTE system to which the disclosure is applicable;

FIG. 3 illustrates a structure of a next-generation mobile communication system to which the disclosure is applicable;

FIG. 4 illustrates a structure of a wireless protocol of a next-generation mobile communication system to which the disclosure is applicable;

FIG. 5 illustrates a procedure for configuring and/or reporting signaling-based QoE measurement according to an embodiment;

FIG. 6 illustrates a procedure for configuring and/or reporting management-based QoE measurement according to an embodiment;

FIG. 7 illustrates a method for configuring dual connectivity (DC) in a terminal according to an embodiment;

FIG. 8A illustrates a method for a terminal configured with DC to report QoE measurement results according to an embodiment;

FIG. 8B illustrates a method for a terminal configured with DC to report QoE measurement results according to an embodiment;

FIG. 9A illustrates a method for a terminal with DC configured to report QoE measurement results according to an embodiment;

FIG. 9B illustrates a method for a terminal with DC configured to report QoE measurement results according to an embodiment;

FIG. 10 illustrates a method for handling QoE configuration information and QoE measurement results related thereto when a terminal with DC configured releases an SCG according to an embodiment;

FIG. 11 illustrates a method for handling QoE configuration information and QoE measurement results related thereto when a terminal with DC configured deactivates an SCG according to an embodiment;

FIG. 12 illustrates an internal structure of a terminal according to an embodiment; and

FIG. 13 illustrates a structure of an NR base station according to an embodiment.

### DETAILED DESCRIPTION

The following description with reference to the accompanying drawings is provided to assist in a comprehensive understanding of embodiments of the disclosure.

Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

In the following description, terms for identifying access nodes and referring to network entities, messages, interfaces between network entities, various identification information, and the like are illustratively used for the sake of convenience. Therefore, the disclosure is not limited by the terms as used below, and other terms with reference to subjects having equivalent technical meanings may be used.

Herein, an element may be expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The disclosure will be described using terms and names defined in the 3rd generation partnership project (3GPP) LTE standards for the convenience of description. However, the disclosure is not limited by these terms and names, and may be applied in the same manner to systems that conform other standards. In the disclosure, the term eNB may be interchangeably used with the term gNB for the convenience of description. That is, a base station described as eNB may indicate gNB.

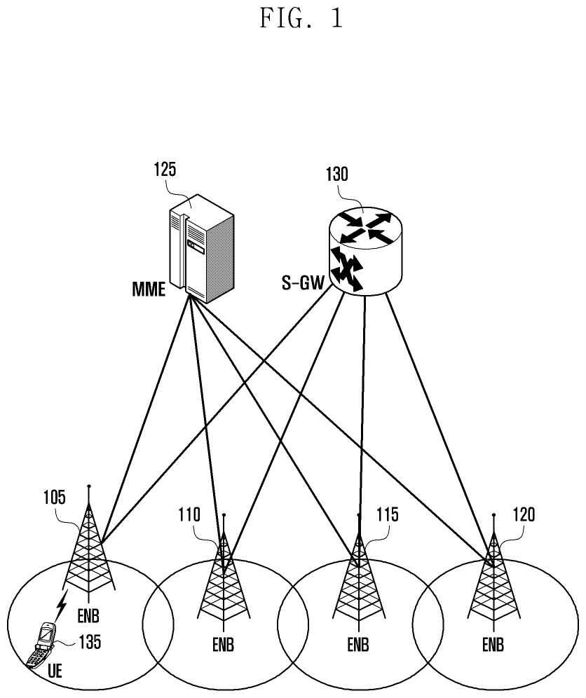

FIG. 1 illustrates the structure of an LTE system to which the disclosure is applicable.

Referring to FIG. 1, a radio access network of the LTE system includes next-generation base stations (e.g., Evolved node Bs (ENBs), Node Bs, or base stations) 105, 110, 115 and 120, a mobility management entity (MME) 125, and a serving-gateway (S-GW) 130. A user equipment 135 (hereinafter, referred to as a UE or a terminal) may access an external network through the ENBs 105 to 120 and the S-GW 130.

In FIG. 1, the ENBs 105 to 120 correspond to conventional Node Bs of a universal mobile telecommunications service (UTMS) system. The ENB is connected to the UE 135 through a radio channel, and performs a more complicated role than the conventional node B. In the LTE system, since all user traffic including a real time service such as a voice over Internet protocol (VOIP) are serviced through a shared channel, an apparatus for collecting and scheduling status information on buffer statuses of UEs, available transmission power status, and channel statuses is required, and the ENBs 105 to 120 serve as this apparatus. One ENB may control a plurality of cells. For example, to implement a transmission rate of 100 Mbps, the LTE system may use orthogonal frequency-division multiplexing (OFDM) as a wireless access technology in a bandwidth of 20 MHz. An adaptive modulation and coding (AMC) scheme of determining a modulation scheme and channel-coding rate is applied depending on the channel status of the UE. The S-GW 130 is a device for providing a data bearer, and generates or discards the data bearer under a control of the MME 125. The MME performs not only a function of managing the mobility of the UE but also various control functions and may be connected to a plurality of ENBs.

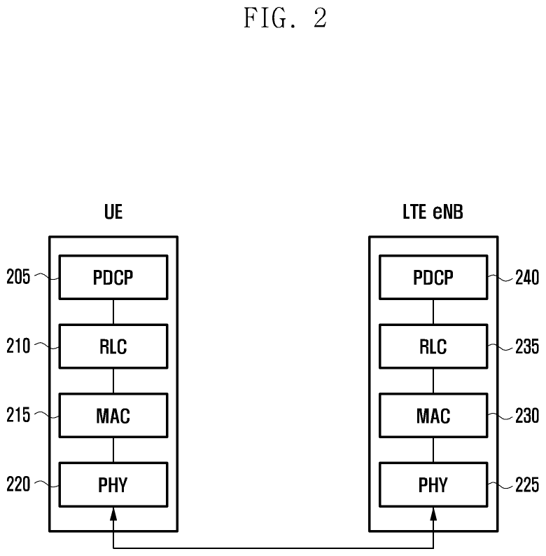

FIG. 2 illustrates the structure of a wireless protocol in an LTE system to which the disclosure is applicable.

Referring to FIG. 2, each of the UE and the ENB includes packet data convergence protocols (PDCPs) 205 and 240, radio link controls (RLCs) 210 and 235, medium access controls (MACs) 215 and 230, in the wireless protocol of the LTE system. The PDCPs 205 and 240 perform an operation of compressing/reconstructing an IP header. The main functions of the PDCP are described below.
Robust header compression and decompression
User data transfer
Sequential delivery of upper layer packet data units (PDUs) at PDCP re-establishment procedure for radio link control acknowledge mode (RLC AM) Sequence re-arrangement for split bearers in DC (only support for RLC AM): PDCP PDU routing for transmission and PDCP PDU reordering for reception)
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM

Ciphering and deciphering

Timer-based SDU discard in uplink.

RLC 210 and 235 reconfigure the PDCP PDU to be the proper size and performs an automatic repeat request (ARQ) operation. The main functions of the RLC are summarized below.
Data transfer of upper layer PDUs
Error correction through ARQ for AM data transfer
Concatenation, segmentation, and reassembly of RLC SDUs for unacknowledged mode (UM) and AM data transfer
Re-segmentation of RLC data PDUs for AM data transfer
Reordering of RLC data PDUs for UM and AM data transfer
Duplication detection for UM and AM data transfer
Protocol error detection for AM data transfer
RLC SDU discard for UM and AM data transfer
RLC reestablishment

The MACs 215 and 230 are connected to various RLC layer devices configured in one UE and perform an operation for multiplexing RLC PDUs to the MAC PDU and de-multiplexing the RLC PDUs from the MAC PDU. The main functions of the MAC are summarized below.
Mapping between logical channels and transport channels
Multiplexing and demultiplexing of MAC SDUs belonging to one or different logical channels into/from transport blocks (TBs) delivered to/from the physical layer on transport channels
Scheduling information reporting
Error correction through hybrid ARQ (HARQ)
Priority handling between logical channels of one UE
Priority handling between UEs by means of dynamic scheduling
Multimedia broadcast multicast service (MBMS) identification
Transport format selection
Padding

The PHY layers 220 and 225 perform an operation for channel-coding and modulating higher-layer data to generate an OFDM symbol and transmitting the OFDM symbol through a radio channel or demodulating and channel-decoding the OFDM symbol received through the radio channel and delivering the demodulated and channel-decoded OFDM symbol to the higher layer.

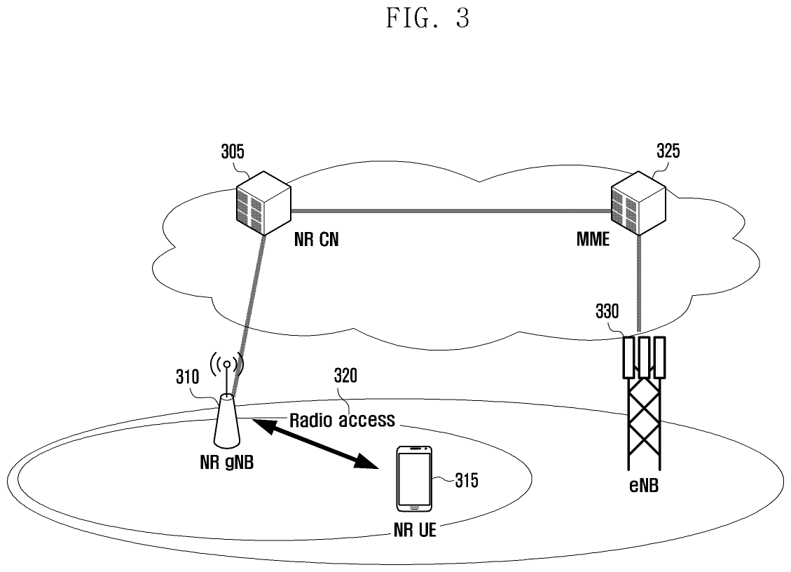

FIG. 3 illustrates the structure of a next-generation mobile communication system to which the disclosure is applicable.

With reference to FIG. 3, a radio access network of the next-generation mobile communication system (hereinafter, referred to as NR or 2G) includes a next-generation base station 310 (New radio node B, hereinafter, referred to as a gNB or an NR NB) and a new radio core network (NR CN) 305 as illustrated. A user terminal 315 (new radio user equipment, hereinafter, referred to as NR UE or a terminal) accesses an external network through the NR gNB 310 and the NR CN 305.

In FIG. 3, the NR gNB 310 corresponds to an evolved Node B (eNB) in a conventional LTE system. The NR gNB may be connected to the NR UE 315 through a radio channel and may provide better service than the conventional node B. Since all user traffic is served through a shared channel in the next-generation mobile communication system, a device for collecting and scheduling status information of buffer statuses, available transmission power statuses, and channel statuses of UEs is required, and the NR NB 310 servers as this apparatus. One NR gNB generally controls a plurality of cells. The NR gNB may have a bandwidth wider than the conventional maximum bandwidth to implement super-high-speed data transmission compared to current LTE, may apply OFDM through radio-access technology, and may further apply beamforming technology. An AMC) scheme of determining a modulation scheme and channel-coding rate is applied depending on the channel status of the UE.

The NR CN 305 performs a function of supporting mobility, configuring a bearer, and configuring QoS. The NR CN is a device for managing the mobility of the UE and various control functions and is connected to a plurality of base stations. The next-generation mobile communication system may be linked to the conventional LTE system, and the NR CN is connected to an MME 325 through a network interface. The MME is connected to an eNB 330, which is a conventional base station.

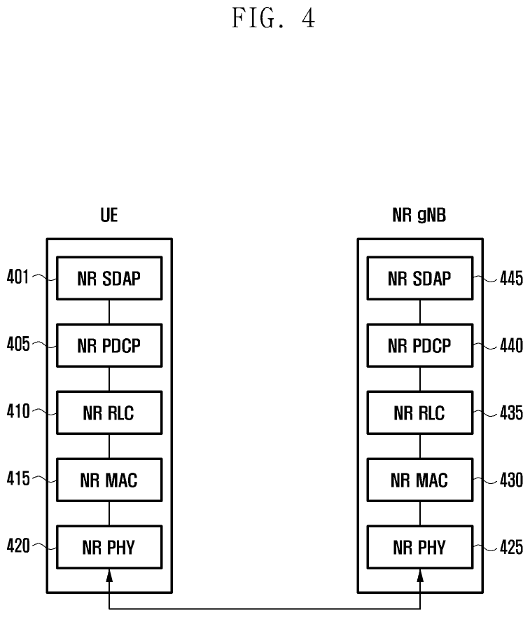

FIG. 4 illustrates the structure of a wireless protocol of a next-generation mobile communication system to which the disclosure is applicable.

Referring to FIG. 4, each of the UE and the NR base station includes NR service data association protocols (SDAPs) 401 and 445, NR PDCPs 405 and 440, NR RLCs 410 and 435, and NR MACs 415 and 430 in the wireless protocol of the next-generation mobile communication system.

The main functions of the NR SDAPs 401 and 445 may include at least one of transfer of user plane data, mapping QoS flow and a data bearer for uplink and downlink, marking a QoS flow ID for uplink and downlink packets, and mapping reflective QoS flow to a data bearer for uplink SDAP PDUs.

With respect to the SDAP layer device, the UE may receive a configuration as to whether to use a header of the SDAP layer device or a function of the SDAP layer device for each PDCP layer device, each bearer, or each logical channel through an RRC message. When the SDAP header is configured, a 1-bit indicator of NAS reflective QoS of the SDAP header and a 1 bit-indicator of AS reflective QoS may indicate that the UE updates or reconfigures information on mapping of QoS flow and a data bearer in uplink and downlink. The SDAP header may include QoS flow ID information indicating the QoS. The QoS information may be used as data-processing-priority or scheduling information to support a seamless service.

The main functions of the NR PDCPs 405 and 440 may include some of the following functions.
Robust header compression and decompression
User data transfer
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink.

The reordering function of the NR PDCP device is a function of sequentially reordering PDCP PDUs received by a lower layer based on a PDCP sequence number, and may include a function of sequentially delivering the reordered data to a higher layer, a function of directly delivering the reordered data without regard to the order, a function of recording PDCP PDUs lost due to the reordering, a function of reporting statuses of the lost PDCP PDUs to a transmitting side, and a function of making a request for retransmitting the lost PDCP PDUs.

The main functions of the NR RLCs 410 and 435 may include some of the following functions.
Data transfer of upper layer PDUs
In-sequence delivery of upper layer PDUs
Out-of-sequence delivery of upper layer PDUs
Error correction through ARQ
Concatenation, segmentation, and reassembly of RLC SDUs
Re-segmentation of RLC data PDUs
Reordering of RLC data PDUs
Duplicate detection
Protocol error detection
RLC SDU discard
RLC reestablishment

In-sequence delivery of the NR RLC device is a function of sequentially delivering RLC PDUs received from a lower layer to a higher layer, and may include, when one original RLC SDU is divided into a plurality of RLC SDUs and then received, a function of reassembling and delivering the RLC SDUs, a function of reordering the received RLC PDUs based on an RLC sequence number or a PDCP sequence number, a function of recording RLC PDUs lost due to the reordering, a function of reporting statuses of the lost RLC PDUs to a transmitting side, a function of making a request for retransmitting the lost RLC PDUs, when there is a lost RLC SDU, a function of sequentially delivering only RLC SDUs preceding the lost RLC SDU to the higher layer, or if a predetermined timer expires even when there is a lost RLC SDU, a function of sequentially delivering all RLC SDUs received before the timer starts to the higher layer, or if a predetermined timer expires even when there is a lost RLC SDU, a function of sequentially delivering all RLC SDUs received up to that point in time to the higher layer. The NR RLC device may process the RLC PDUs sequentially in the order of reception thereof (according to an arrival order regardless of a serial number or a sequence number) and may deliver the RLC PDUs to the PDCP device regardless of the sequence thereof (out-of-sequence delivery). In the case of segments, the NR RLC device may receive segments that are stored in the buffer or are to be received in the future, reconfigure the segments to be one RLC PDU, process the RLC PDU, and then deliver the same to the PDCP device. The NR RLC layer may not include a concatenation function, and the function may be performed by the NR MAC layer or may be replaced with a multiplexing function of the NR MAC layer.

The out-of-sequence delivery of the NR RLC device is a function of delivering RLC SDUs received from a lower layer directly to a higher layer regardless of the sequence of the RLC SDUs, and may include, when one original RLC SDU is divided into a plurality of RLC SDUs and then received, a function of reassembling and delivering the RLC PDUs and a function of storing RLC SNs or PDCP SNs of the received RLC PDUs, reordering the RLC PDUs, and recording lost RLC PDUs.

The NR MACs 415 and 430 may be connected to a plurality of NR RLC layer devices configured in one UE and main functions of the NR MAC may include some of the following functions.
Mapping between logical channels and transport channels
Multiplexing and demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layers 420 and 425 perform an operation for channel-coding and modulating higher layer data to generate an OFDM symbol and transmitting the OFDM symbol through a radio channel or demodulating and channel-decoding the OFDM symbol received through the radio channel and delivering the demodulated and channel-decoded OFDM symbol to the higher layer.

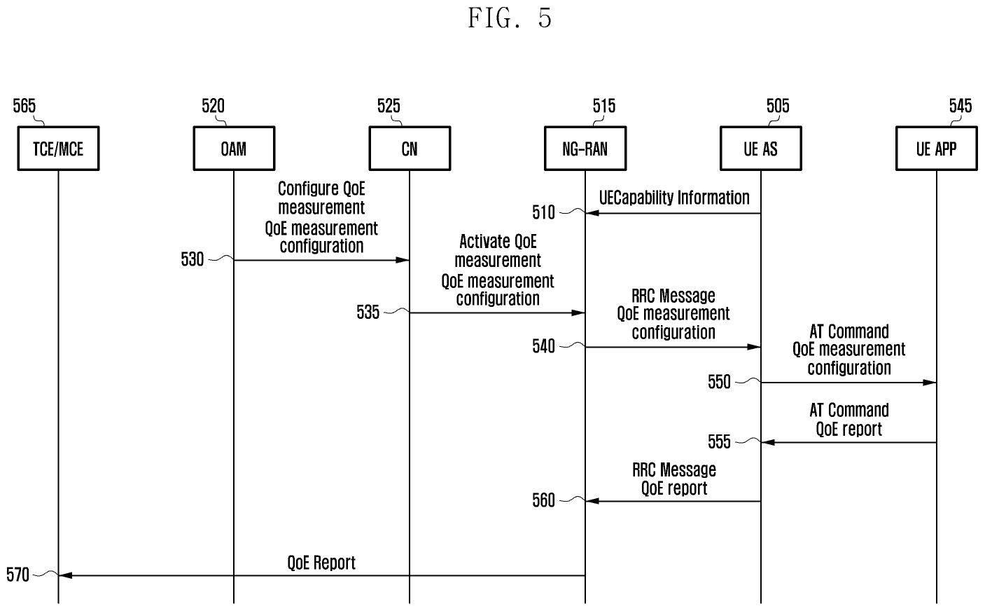

FIG. 5 illustrates a procedure for configuring and/or reporting signaling-based QoE measurement according to an embodiment.

With reference to FIG. 5, in step 510, the UE access stratum (AS) 505 may embed information indicating which QoE measurements are supported through application layers measurements in a UE capability information message (e.g., UECapabilityInformation) and transmit the same to the base station 515.

The UE capability information message may also embed capability information about whether the UE AS 505 may segment an RRC message (e.g., MeasurementReportAppLayer) reporting the QoE measurement results and transmit it to the base station 515. For example, the UE capability information message may embed the parameters shown in Table 1 below.

TABLE 1

| AppLayerMeasParameters-r17 ::= | SEQUENCE { | |
|---|---|---|
| qoe-Streaming-MeasReport-r17 | ENUMERATED {supported} | OPTIONAL, |
| qoe-MTSI-MeasReport-r17 | ENUMERATED {supported} | OPTIONAL, |
| qoe-VR-MeasReport-r17 | ENUMERATED {supported} | OPTIONAL, |

| | | |
|---|---|---|
| ran-VisibleQoE-Streaming-MeasReport-r17 | ENUMERATED | {supported} |

OPTIONAL,

| | | |
|---|---|---|
| ran-VisibleQoE-VR-MeasReport-r17 | ENUMERATED {supported} | OPTIONAL, |

| | | |
|---|---|---|
| ul-MeasurementReportAppLayer-Seg-r17 | ENUMERATED | {supported} |

OPTIONAL,
...

The UE capability information message may embed whether the UE supports QoE measurements through application layer measurements for MBMS, extended reality (XR), etc. In this case, the UE capability information message may embed whether separate QoE measurement is supported for multimedia broadcast services, multimedia multicast services, etc. or whether QoE measurement is supported in common without distinction between multimedia broadcast services and multimedia multicast services.

Whether QoE measurement is supported depending on the RRC status for multimedia broadcast services may be included in the message. For example, the UE may support QoE measurement for multimedia broadcast services only in RRC connected mode (RRC_CONNECTED) or may support QoE measurement for multimedia broadcast services only in both RRC idle mode (RRC_IDLE) and RRC inactive mode (RRC_INACTIVE). Alternatively, the UE may support QoE measurement for multimedia broadcast services regardless of RRC status.

In step 530, operations administration and maintenance (OAM) 520 may provide QoE measurement configuration information to a core network (CN) 525.

In step 535, the CN 525 may activate QoE measurement by transmitting the QoE measurement configuration information received in step 530 to the base station 515.

In step 540, the base station 515 may embed the QoE measurement configuration information received from the CN in step 535 in a predetermined RRC message (e.g., RRCReconfiguration or RRCResume) and transmit the same to the UE AS 515.

The QoE measurement configuration information (AppLayerMeasConfig) embedded in the predetermined RRC message may include the parameters shown in Table 2 and Table 3 below.

TABLE 2

| | |
|---|---|
| AppLayerMeasConfig-r17 ::= | SEQUENCE { |

```
  measConfigAppLayerToAddModList-r17 SEQUENCE (SIZE (1..maxNrofAppLayerMeas-r17)) OF
MeasConfigAppLayer-r17 OPTIONAL, -- Need N
  measConfigAppLayerToReleaseList-r17 SEQUENCE (SIZE (1..maxNrofAppLayerMeas-r17)) OF
MeasConfigAppLayerId-r17 OPTIONAL, -- Need N
```

| | | |
|---|---|---|
| rrc-SegAllowed-r17 | ENUMERATED {enabled} | OPTIONAL, |

-- Need R
...
{

| | |
|---|---|
| MeasConfigAppLayer-r17 ::= | SEQUENCE { |
| measConfigAppLayerId-r17 | MeasConfigAppLayerId-r17, |

measConfigAppLayerContainer-r17 OCTET STRING (SIZE (1..8000))
OPTIONAL, -- Need N

| | |
|---|---|
| serviceType-r17 | ENUMERATED {streaming, mtsi, vr, spare5, spare4, spare3, spare2, spare1} |

OPTIONAL, -- Need M

| | | |
|---|---|---|
| pauseReporting | BOOLEAN | OPTIONAL, -- Need |

M

| | |
|---|---|
| transmissionOfSessionStartStop BOOLEAN | OPTIONAL, -- |

Need M

| | | |
|---|---|---|
| ran-VisibleParameters-r17 | SetupRelease {RAN-VisibleParameters-r17} | OPTIONAL, |

-- Need M
...
}
RAN-VisibleParameters-r17 ::= SEQUENCE

| | |
|---|---|
| ran-VisiblePeriodicity-r17 | ENUMERATED {ms120, ms240, ms480, ms640, ms1024} |

OPTIONAL, -- Need S

| | |
|---|---|
| numberOfBufferLevelEntries-r17 INTEGER (1..8) | OPTIONAL, - |

- Need R

| | |
|---|---|
| reportPlayoutDelayForMediaStartup-r17 BOOLEAN | OPTIONAL, |

-- Need M
...
}
-- TAG-APPLAYERMRASCONFIG-STOP
-- ASN1STOP

TABLE 3
AppLayerMeasConfig field descriptions
measConfigAppLayerContainer
The field contains configuration of application layer measurements, see Annex L (normative) in TS 26.247 [68],
clause 16.5 in TS 26.114 [69] and TS 26.118 [70].
pauseReporting
The field indicates whether the transmission of measReportAppLayerContainer is paused or not.
ran-VisibleParameters
The field indicates whether RAN visible application layer measurements shall be reported or not. The field is
optionally present when serviceType is set to streaming or vr. Otherwise, it is absent.
rrc-SegAllowed
This field indicates that RRC segmentation of MeasurementReportAppLayer is allowed. It may be present only if the
UE supports RRC segmentation of the MeasurementReportAppLayer message in UL.
serviceType
Indicates the type of application layer measurement. Value streaming indicates Quality of Experience Measurement
Collection for streaming services (see TS 26.247 [68]), value mtsi indicates Quality of Experience Measurement
Collection for MTSI (see TS 26.114 [69]). value vr indicates Quality of Experience Measurement Collection for VR
service (see TS 26.118 [70]). The network always configures serviceType when application layer measurements are
initially configured and at fullConfig.
transmissionOfSessionStartStop
The field indicates whether the UE shall transmit indications when sessions in the application layer start and stop. The
UE transmits a session start indication upon configuration of this field if a session already has started in the
application layer.
RAN-VisibleParameters field descriptions
numberOfBufferLevelEntries
The field contains the maximum number of buffer level entries that can be reported for RAN visible application layer
measurements.
ran-VisiblePeriodicity
The field indicates the periodicity of RAN visible reporting. Value ms120 indicates 120 ms, value ms240 indicates
240 ms and so on.
reportPlayoutDelayForMediaStartup
The field indicates whether the UE shall report Playout Delay for Media Startup for RAN visible application layer
measurements.

The AppLayerMeasConfig may also include QoE measurement configuration information for multimedia broadcast services. For example, multimedia broadcast services may be indicated in the service Type included in AppLayerMeasConfig, or a separate indicator may be inserted to include QoE measurement configuration information for multimedia broadcast services. Alternatively, it may include an indicator (e.g., mbs-SessionList) regarding whether QoE is measured for each MBS session.

For the multimedia broadcast services, QoE measurement configuration information may be applied to all RRC statuses (RRC_IDLE, RRC_INACTIVE, RRC_CONNECTED) of the UE, or may be applied to at least one RRC status. That is, AppLayerMeasConfig may be indicated to which RRC statuses (any combination of RRC_IDLE, RRC_INACTIVE and RRC_CONNECTED) the QoE measurement configuration information for multimedia broadcast services is applied.

Alternatively, a new timer value may be included to indicate the QoE measurement performance period for multimedia broadcast services. That is, when the new timer value is included, the UE may start or restart a new timer with the new timer value received when receiving AppLayerMeasConfig from the base station. Alternatively, the UE may start or restart a new timer with the new timer value received when transitioning to RRC idle mode or RRC deactivated mode. When the new timer that has started expires, the UE may release QoE measurement configuration information for multimedia broadcast services. The UE AS that has received AppLayerMeasConfig may perform the procedures described in Table 4 below.

TABLE 4

| | |
|---|---|
| 1> | if measConfigAppLayerToReleaseList is included in appLayerMeasConfig within |

RRCReconfiguration or RRCResume:

| | |
|---|---|
| 2> | for each measConfigAppLayerId value included in the |

measConfigAppLayerToReleaseList:

| | |
|---|---|
| 3> | forward the measConfigAppLayerId and inform upper layers about the |

release of the application layer measurement configuration including any RAN visible
application layer measurement configuration;

| | |
|---|---|
| 3> | discard any application layer measurement report received from upper |

layers;

| | |
|---|---|
| 3> | consider itself not to be configured to send application layer |

measurement report for the measConfigAppLayerId.

| | |
|---|---|
| 1> | if measConfigAppLayerToAddModList is included in appLayerMeasConfig |

within RRCReconfiguration or RRCResume:

| | |
|---|---|
| 2> | for each measConfigAppLayerId value included in the |

measConfigAppLayerToAddModList:

| | |
|---|---|
| 3> | if measConfigAppLayerContainer is included for the corresponding |

MeasConfigAppLayer configuration:

| | |
|---|---|
| 4> | forward the measConfigAppLayerContainer, the |

measConfigAppLayerId and the serviceType to upper layers considering the serviceType;

| | |
|---|---|
| 3> | consider itself to be configured to send application layer measurement |

report for the measConfigAppLayerId in accordance with 5.7.16;

| | |
|---|---|
| 3> | forward the transmissionOfSessionStartStop, if configured, and |

measConfigAppLayerId to upper layers considering the serviceType;

| | |
|---|---|
| 3> | if ran-VisibleParameters is set to setup and the parameters have been |

received:

| | |
|---|---|
| 4> | forward the measConfigAppLayerId, the ran-VisiblePeriodicity, if |

configured, the numberOfBufferLevelEntries, if configured, and the
reportPlayoutDelayForMediaStartup, if configured, to upper layers considering the
serviceType;

| | |
|---|---|
| 3> | else if ran-VisibleParameters is set to release: |

| | |
|---|---|
| 4> | forward the measConfigAppLayerId and inform upper layers |

about the release of the RAN visible application layer measurement configuration;

| | |
|---|---|
| 3> | if pauseReporting is set to true: |

| | |
|---|---|
| 4> | if at least one segment, but not all segments, of a segmented |

MeasurementReportAppLayer message containing an application layer measurement
report associated with the measConfigAppLayerId has been submitted to lower layers for
transmission:

| | |
|---|---|
| 5> | submit the remaining segments of the |

MeasurementReportAppLayer message to lower layers for transmission;

| | |
|---|---|
| 4> | suspend submitting application layer measurement report |

containers to lower layers for the application layer measurement configuration
associated with the measConfigAppLayerId;

| | |
|---|---|
| 4> | store any previously or subsequently received application layer |

measurement report containers associated with the measConfigAppLayerId for which no
segment, or full message, has been submitted to lower layers for transmission;

| | |
|---|---|
| 3> | else if pauseReporting is set to false and if transmission of application |

layer measurement report containers has previously been suspended for the application
layer measurement configuration associated with the measConfigAppLayerId:

| | |
|---|---|
| 4> | submit stored application layer measurement report containers to |

lower layers, if any, for the application layer measurements configuration associated
with the measConfigAppLayerId;

| | |
|---|---|
| 4> | resume submitting application layer measurement report |

containers to lower layers for the application layer measurement configuration
associated with the measConfigAppLayerId;

In step 550, the UE AS 505 which has received AppLayerMeasConfig, may deliver the QoE measurement configuration information to the application layer (UE APP) 545 of the UE through an AT command.

In step 555, the UE APP 545 may perform QoE measurement according to the QoE measurement configuration information received in step 550 and report the measurement result to the UE AS 505 through the AT command according to the configuration information.

In step 560, the UE AS 505 may report the measurement results to the base station 515 through a predetermined RRC message (e.g., MeasReportAppLayer) based on the information received in step 555. SRB4 may be used to report the QoE measurement results. The predetermined RRC message may include parameters as shown in Table 5 below.

TABLE 5
MeasurementReportAppLayer-r17 ::= SEQUENCE {

| | |
|---|---|
| criticalExtensions | CHOICE { |

measurementReportAppLayer-r17 MeasurementReportAppLayer-r17-IEs,

| | |
|---|---|
| criticalExtensionsFuture | SEQUENCE { } |

```
  }
}
MeasurementReportAppLayer-r17-IEs ::= SEQUENCE {
  measurementReportAppLayerList-r17 MeasurementReportAppLayerList-r17,
```

| | | |
|---|---|---|
| lateNonCriticalExtension | OCTET STRING | OPTIONAL, |
| nonCriticalExtension | SEQUENCE{ } | OPTIONAL |

}
MeasurementReportAppLayerList-r17 ::= SEQUENCE (SIZE (1..maxNrofAppLayerMeas-r17)) OF
MeasReportAppLayer-r17

| MeasReportAppLayer-r17 ::= | SEQUENCE { | |
|---|---|---|
| measConfigAppLayerId-r17 | MeasConfigAppLayerId-r17, | |
| measReportAppLayerContainer-r17 OCTET STRING | | OPTIONAL, |
| appLayerSessionStatus-r17 | ENUMERATED {started, stopped} | OPTIONAL, |
| ran-VisibleMeasurements-r17 | RAN-VisibleMeasurements-r17 | OPTIONAL |
| } | | |

RAN-VisibleMeasurements-r17 ::= SEQUENCE {

| | |
|---|---|
| appLayerBufferLevelList-r17 | SEQUENCE (SIZE (1..8)) OF AppLayerBufferLevel-r17 |

OPTIONAL,

| | |
|---|---|
| playoutDelayForMediaStartup-r17 INTEGER (0..30000) | OPTIONAL, |

| | |
|---|---|
| pdu-SessionIdList-r17 | SEQUENCE (SIZE (1..maxNrofPDU-Sessions-r17)) OF PDU-SessionID |

OPTIONAL,
...
}

The UE AS 505 may transmit a predetermined RRC message including the QoE measurement result report to the base station 515 based on the procedure shown in Table 6 below.

TABLE 6

| 1> | for each measConfigAppLayerId: | |
|---|---|---|
| | 2> | if the UE AS has received application layer measurement report from upper |

layers which has not been transmitted; and

| | |
|---|---|
| 2> | if the application layer measurement reporting has not been suspended for |

the measConfigAppLayerId associated with the application layer measurement report
according to clause 5.3.5.13d:

| | |
|---|---|
| 3> | set the measReportAppLayerContainer in the |

MeasurementReportAppLayer message to the received value in the application layer
measurement report;

| | |
|---|---|
| 2> | set the measConfigAppLayerId in the MeasurementReportAppLayer |

message to the value of the measConfigAppLayerId received together with application
layer measurement report information;

| | |
|---|---|
| 2> | if session start or stop information has been received from upper layers for |

the measConfigAppLayerId:

| | |
|---|---|
| 3> | set the appLayerSessionStatus to the received value of the application |

layer measurement information;

| | |
|---|---|
| 2> | if RAN visible application layer measurement report has been received |

from upper layers:

| | |
|---|---|
| 3> | for each appLayerBufferLevel value in the received RAN visible |

application layer measurement report:

| | |
|---|---|
| 4> | set the appLayerBufferLevel values in the |

appLayerBufferLevelList to the buffer level values received from the upper layer in the
order with the first appLayerBufferLevel value set to the newest received buffer level
value, the second appLayerBufferLevel value set to the second newest received buffer
level value, and so on until all the buffer level values received from the upper layer have
been assigned or the maximum number of values have been set according to
appLayerBufferLevel, if configured;

| | |
|---|---|
| 3> | set the playoutDelayForMediaStartup to the received value in the |

RAN visible application layer measurement report, if any;

| | |
|---|---|
| 3> | for each PDU session ID value indicated in the received RAN visible |

application layer measurement report, if any:

| | |
|---|---|
| 4> | set the PDU-SessionID field in the pdu-SessionIdList to the |

indicated PDU session ID value;

| | |
|---|---|
| 2> | if the encoded RRC message is larger than the maximum supported size of |

one PDCP SDU specified in TS 38.323 [5]:

| | |
|---|---|
| 3> | if the RRC message segmentation is enabled based on the field rrc- |

SegAllowed received in appLayerMeasConfig:

| | |
|---|---|
| 4> | initiate the UL message segment transfer procedure as specified in |

clause 5.7.7;

| | |
|---|---|
| 3> | else: |

| | |
|---|---|
| 4> | discard the RRC message; |

| | |
|---|---|
| 2> | else: |

| | |
|---|---|
| 3> | submit the MeasurementReportAppLayer message to lower layers for |

transmission upon which the procedure ends.

In step 570, the base station 515 may deliver the measurement result report received in step 565 to the configured final destination (trace collection entity (TCE) or measurement collection entity (MCE)) 565.

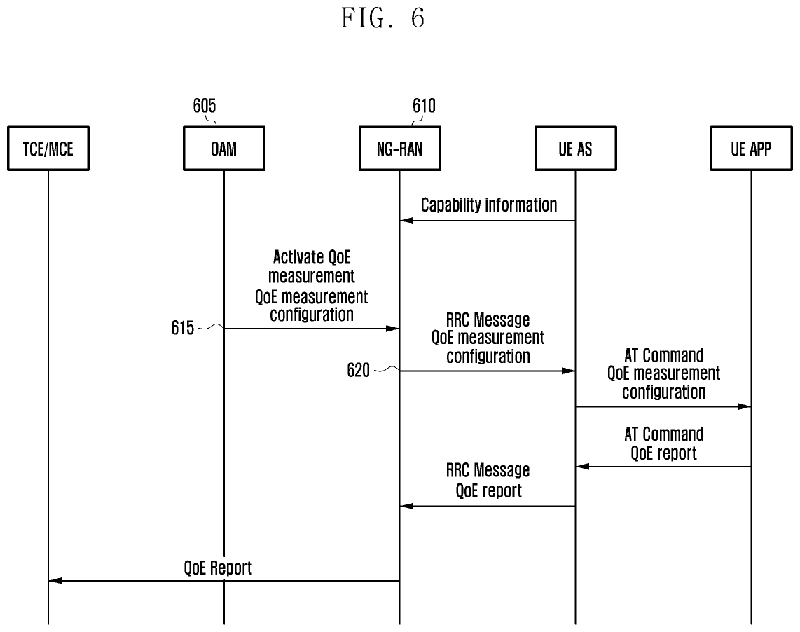

FIG. 6 illustrates a procedure for configuring and/or reporting management-based QoE measurement according to an embodiment.

The management-based QoE configuration and reporting procedures may be substantially similar to the signaling-based QoE configuration and/or reporting procedures described above in FIG. 5 (FIG. 5). Therefore, in this specification, only the differences in the management-based method are described below, and other procedures and explanations may refer to the description with respect to FIG. 5.

In the management-based method, in step 615, an OAM 605 may activate QoE measurement by directly transmitting the QoE measurement configuration to the base station 610 without going through CN (615).

The base station 610 that has received the QoE measurement configuration searches for a single or plurality of UEs that meet various conditions (e.g., area scope, application layer capability, service type). Also, in step 620, the base station 610 may deliver the QoE measurement configuration to each of the UEs through an RRC message (e.g., RRCReconfiguration or RRCResume) (620).

Other procedures and message formats may be considered the same as the description with respect to FIG. 5 (signaling-based method).

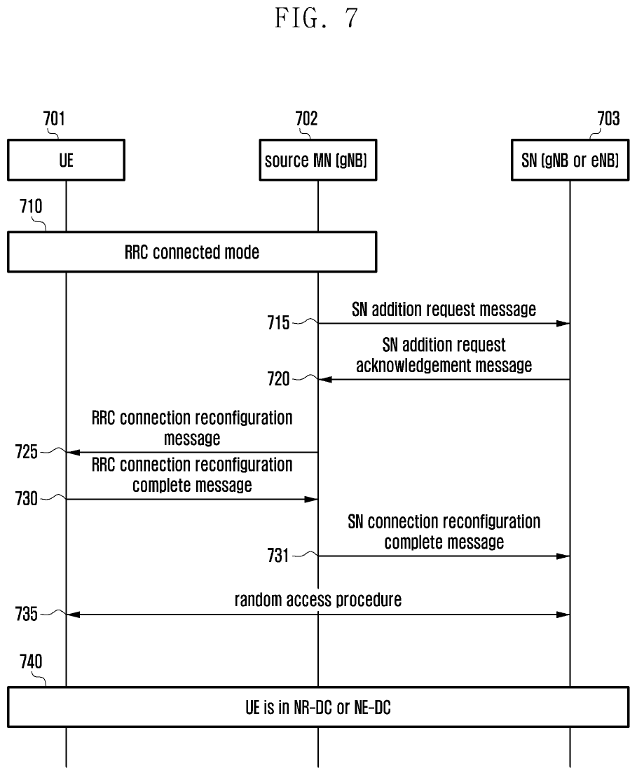

FIG. 7 illustrates a method for configuring DC in the UE according to an embodiment.

More specifically, FIG. 7 illustrates the overall flow diagram in which NE-DC or NR-DC is configured to the UE.

Referring to FIG. 7, in step 710, a UE 701 may establish RRC connection with a primary cell (PCell) or special cell (SpCell) of master node) of a source MN 702 and may be in RRC connected mode (RRC_CONNECTED). The PCell of the source MN is connected to a 5G CN, so the UE may receive services from the 5G CN.

In step 715, the source MN 702 may initiate a secondary node (SN) addition procedure to add an SN 703. For example, in step 715, the source MN may transmit an SN addition request message (e.g., SgNB addition request or SN addition request) to the SN 703.

In step 720, the SN 703 may transmit an SN addition request acknowledgment message (e.g., SgNB addition request acknowledge or SN addition request acknowledge) to the MN 702 in response to step 715. The SN addition request acknowledgment message may embed an RRC connection reconfiguration message (RRCReconfiguration in NR or RRCConnectionReconfiguration in LTE).

In step 725, the MN 702 may transmit the RRC connection reconfiguration message received in step 720 to the UE 701 through signaling radio bearer 1 (SRB1).

In step 730, the UE 701 may apply the RRC connection reconfiguration message received in step 720 and transmit an RRC connection reconfiguration complete message (e.g., RRCReconfigurationComplete in NR or RRCConnectionReconfigurationComplete in LTE) to the MN 702 through SRB1. The RRC connection reconfiguration complete message may embed an SN connection reconfiguration complete message (e.g., SgNB reconfiguration complete or SN reconfiguration complete).

In step 731, the MN 702 may deliver the SN connection reconfiguration complete message to the SN 703.

In step 735, the RRC layer device of the UE 701 may initiate a random access procedure with the primary secondary cell (PSCell) of the SN 703. For reference, the order of steps 730, 731, and 735 may be changed depending on UE implementation. For example, the UE 701 may transmit an RRC connection reconfiguration complete message to the MN 702 after initiating or successfully completing a random access procedure for the PSCell.

In step 740, the UE 701 may operate with NR-DC (PSCell is NR cell) or NE-DC (PSCell is LTE cell) configured.

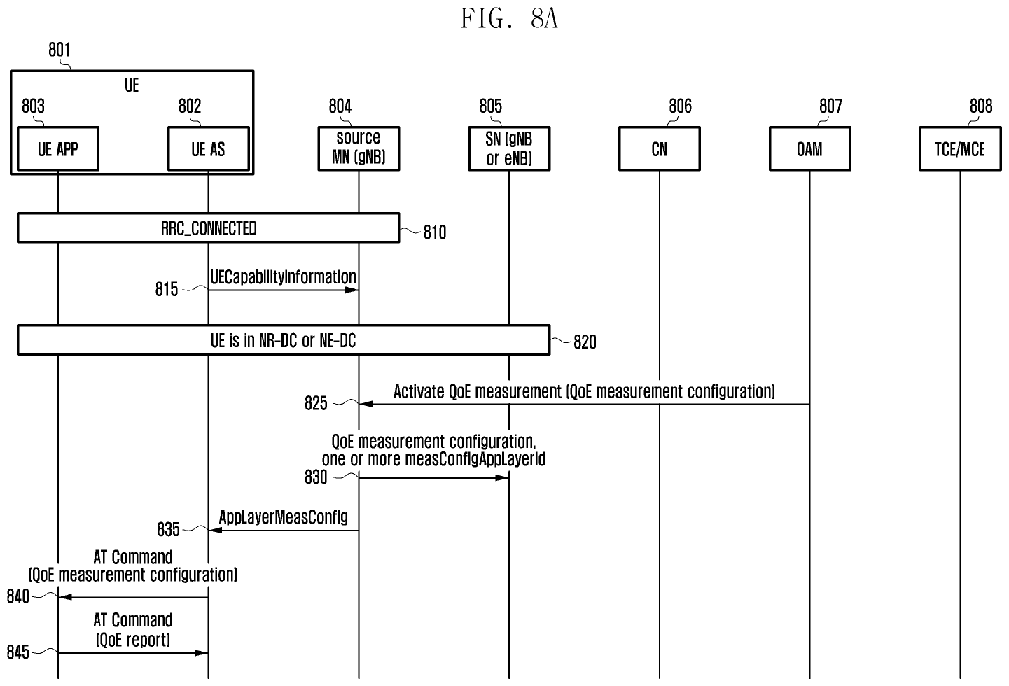

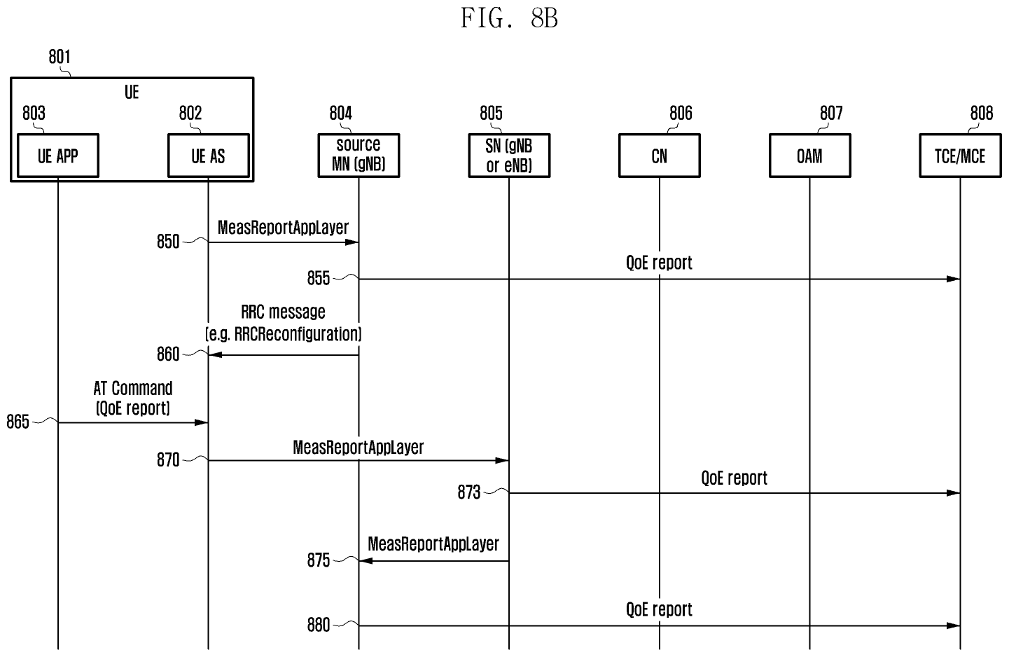

FIGS. 8A and 8B illustrate a method for the UE with DC configured to report QoE measurement results according to an embodiment.

More specifically, FIGS. 8A and 8B illustrate a procedure in which the UE configured with NR-DC or NE-DC reports QoE measurement results to the base station based on QoE measurement configurations.

Referring to FIGS. 8A and 8B, both a UE AS 802 and a UE application layer (UE APP) 803 may be collectively referred to as a UE 801. The base station 804 may be referred to as an MN.

The UE 801 is not limited to the MN in NE-DC or NR-DC and may receive QoE configuration information from the MN and/or SN. and may include information that may report the QoE measurement results to the MN and/or SN.

In step 810, the user equipment (UE) 801 may establish an RRC connection with the base station 804 to be in the RRC connected mode (RRC_CONNECTED).

In step 815, the UE AS 802 may transmit a UE capability information message (e.g., UECapabilityInformation) to the base station 804. The information embedded in the UE capability information message may be as in the above-described embodiment.

The UE capability information message may include information indicating whether NE-DC or NR-DC is supported. The UE capability information message is not limited with respect to the MN in the NE-DC or NR-DC and may receive QoE configuration information from the MN and/or SN and may include information that may report QoE measurement results to the MN and/or SN.

In step 820, the UE 801 may be configured for NR-DC or NE-DC. The UE 801 in NR-DC or NE-DC may transmit and receive data from the MN 804 and SN 805. The flowchart of configuring NR-DC or NE-DC for the UE 801 may follow the above-described embodiment.

In step 825, an OAM 807 may provide QoE measurement configuration information to the MN 804 to activate QoE measurement. The measurement QoE measurement configuration information may include at least one of a service type (serviceType) on which QoE measurement is to be performed, management collection entity (MCE) IP Address, QoE configuration information (measConfigAppLayerContainer), and QoE reference. The above-described information may be in one or more pieces.

In step 830, the MN 804 may deliver at least one of the QoE measurement configuration information received from the OAM 807 to the SN 805.

As disclosed herein, the MN 804 delivers the measConfigAppLayerId mapped to each measReportAppLayerContainer to the SN 805. This is to prevent the same measConfigAppLayerId from being assigned to the UE AS 802 when the SN 805 receives QoE measurement configurations from the OAM in the future. When the same measConfigAppLayerId is assigned to the UE AS 802, even if the MN 804 or SN 805 receives a QoE report from the UE AS 802, it cannot be determined to which QoE reference or MCE IP Address the measConfigAppLayerId is mapped since the message may not be properly delivered to a final destination TCE) or MCE 808. Accordingly, the MN 804 may deliver at least one of serviceType, MCE IP Address, QoE reference, and measConfigAppLayerContainer mapped to each measConfigAppLayerId to the SN 805 along with measConfigAppLayerId.

The MN 804 may inform the SN 805 of an explicit information element or without a separate indicator that the UE AS 802 reports a QoE report to the MN 804. Alternatively, it is indicated for each measConfigAppLayerId that a reporting leg is changed from the MN 804 to the SN 805 (or from the SN 805 to the MN 804), so the UE may transmit MeasReportAppLayer to the MN 804 and SN 805 accordingly.

As an example, when the UE is configured to report a specific measConfigAppLayerId to the MN 804, the UE may transmit to the MN 804, the QoE measurement result for measConfigAppLayerId, which is configured to be reported to the MN. When other specific MeasConfigAppLayerId is configured to be reported to the SN 805, the UE may transmit to the SN 805, the QoE measurement results for measConfigAppLayerId, which is configured to be reported to the SN. The MN 804 may configure to the UE to report the entire QoE report (i.e., MeasReportAppLayer) to the SN 805, so the MN 804 may need to deliver the above information to the SN 805.

In step 835, the MN 804 may embed the QoE measurement configuration information (AppLayerMeasConfig) in a predetermined RRC message (e.g., RRCReconfiguration or RRCResume) through SRB1 and transmit the same to the UE AS 802. The UE operation for AppLayerMeasConfig configuration and reception of the configuration may be as in the above-described embodiment.

In step 840, the UE AS 802 may deliver all or some of the AppLayerMeasConfig received through the AT Command to the UE APP 803.

In step 845, the UE APP 803 may perform QoE measurement according to the configuration information received in step 840 and report the QoE measurement result to the UE AS 802 through the AT Command according to the configuration information.

In step 850, the UE AS 802 may report the QoE measurement result to the MN 804 through a predetermined RRC message (e.g., MeasReportAppLayer) based on the information received in step 845. The UE AS 802 may use signaling radio bearer 4 (SRB4) to report the QoE measurement results. The information included in the predetermined RRC message and the procedure for transmitting the information may be as in the above-described embodiment.

In step 855, the MN 804 may deliver the QoE measurement result information received in step 850 to the final destination (TCE or MCE) 808.

In step 860, the MN 804 may transmit an RRC message to configure to indicate the UE AS 802 to report MeasReportAppLayer to the SN 805.

For example, when congestion occurs because of a lot of load (for example, when it needs to be served to many UEs), the MN 804 may transmit a predetermined RRC message to the UE AS 802 to indicate the UE AS 802 to report MeasReportAppLayer to the SN 805.

For example, the predetermined RRC message may refer to an RRC connection reconfiguration message (RRCReconfiguration message) or RRC connection resumption message (RRCResume message).

By indicating the UE AS 802 to change the reporting leg from the MN 804 to the SN 805 for each measConfigAppLayerId, the UE AS 802 may transmit MeasReportAppLayer to the MN 804 and SN 805 accordingly. That is, when the UE is configured to report a specific measConfigAppLayerId to the MN 804, the UE may transmit to the MN 804, the QoE measurement result for measConfigAppLayerId, which is configured to be reported to the MN. When the UE is configured to report another specific measConfigAppLayerId to the SN 805, the UE may transmit to the SN 805, the QoE measurement result for measConfigAppLayerId, which is configured to be reported to the SN.

Prior to step 860, the MN 804 may inform the SN 905 that it configures the UE AS 802 to report MeasReportAppLayer to the SN 805. Accordingly, the SN 805 may inform the MN 804 whether to acknowledge.

Alternatively, step 860 may be performed in step 835. For example, the MN 804 may configure the UE AS 802 to report to the SN 805 when first configuring AppLayerMeasConfig. Alternatively, by indicating to change the reporting leg from the MN 804 to the SN 805 for each measConfigAppLayerId, the UE may transmit MeasReportAppLayer to the MN 804 and SN 805 accordingly. As an example, when the UE is configured to report a specific measConfigAppLayerId to the MN 804, the UE may transmit to the MN 804, the QoE measurement results for measConfigAppLayerId, which is configured to be reported to the MN. When the UE is configured to report another specific MeasConfigAppLayerId to the SN 805, the UE may transmit to the SN 805, the QoE measurement results for measConfigAppLayerId, which is configured to be reported to the SN.

The MN 804 may configure to the UE to report the entire QoE report (i.e., MeasReportAppLayer) to the SN 805, so the MN 804 may need to deliver the above information to the SN 805.

In step 865, the UE APP 803 may perform the QoE measurement according to the configuration information received in step 840 and report the QoE measurement result to the UE AS 802 through the AT command according to the configuration information.

In step 870, the UE AS 802 may report the QoE measurement result to the SN 805 through a predetermined RRC message (e.g., MeasReportAppLayer) based on the information received in step 865. The new SRB x (new signaling radio bearer x, i.e., SRB5) may be used to report the QoE measurement results. A split SRB4 or SRB3 or SRB2 or new split SRBx may be also used.

In step 873, the SN 805 may directly deliver the QoE measurement result information received in step 870 to the final destination (TCE or MCE) 808. In step 880, the SN 805 may deliver the MeasReportAppLayer received in step 870 to the MN 804 (875) and deliver the measurement result information received by the MN to the final destination (TCE or MCE) 808.

Disclosed is a method for coordination for each node so that the measConfigAppLayerId assigned to the UE does not have the same value for all MNs and SNs or all cell groups (i.e., measConfigAppLayerId is unique across the cell groups).

Disclosed herein is a method in which the UE configured to report MeasReportAppLayer to the MN reports the MeasReportAppLayer to the SN (a method in which the UE configured to report MeasReportAppLayer to the SN reports the MeasReportAppLayer to the MN) when congestion occurs in the MN or SN and signaling procedures and necessary elements of the MN and SN accordingly.

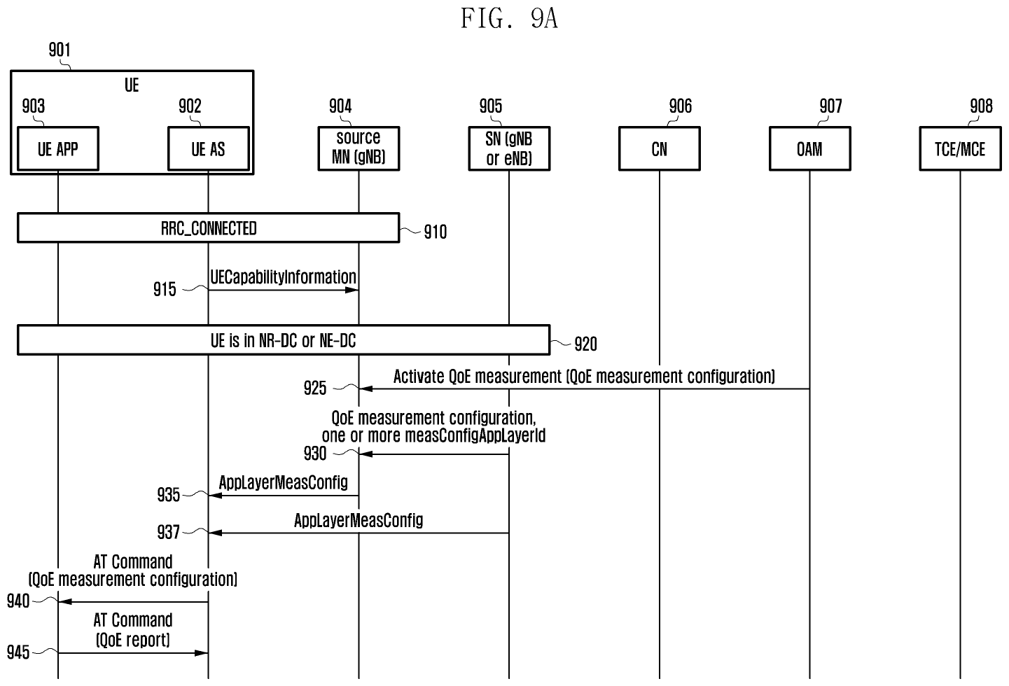

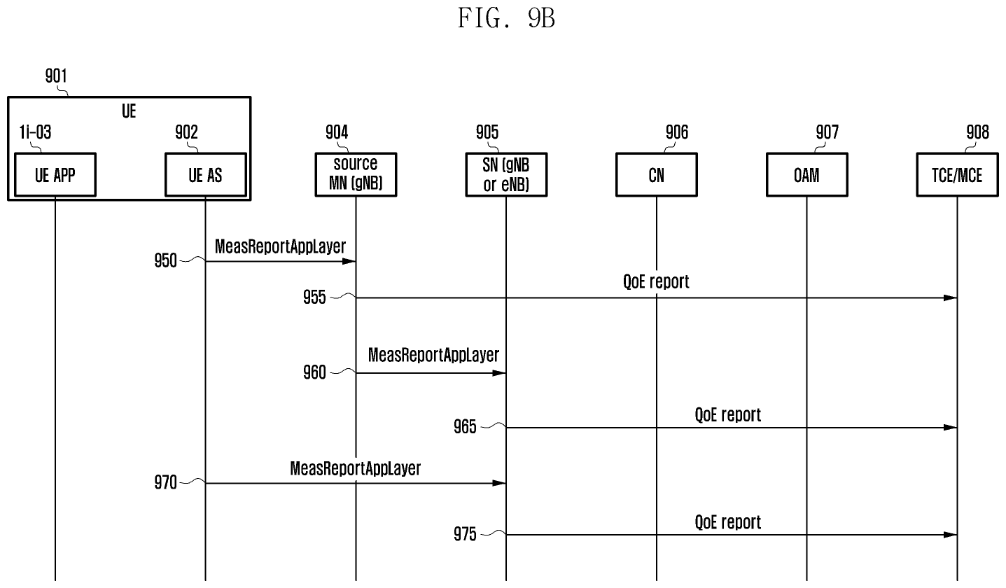

FIGS. 9A and 9B illustrate a method for the UE with DC configured to report QoE measurement results according to an embodiment.

Referring to FIGS. 9A and 9B, a procedure is provided in which the UE configured with NR-DC or NE-DC reports the QoE measurement results to the base station based on the QoE measurement configurations.

Both the UE AS 902 and the UE application layer (APP) 903 may be collectively referred to as the UE 901. The base station 904 may be referred to as an MN.

In step 910, the UE 901 may establish an RRC connection with the base station 904 to be in the RRC connected mode (RRC_CONNECTED).

In step 915, the UE AS 902 may transmit a UE capability information message (e.g., UECapabilityInformation) to the base station 904. The information embedded in the UE capability information message may be as in the above-described embodiment.

In step 920, the UE 901 may be configured for NR-DC or NE-DC. The UE 901 in NR-DC or NE-DC may transmit and receive data from the MN 904 and SN 905. Configuring NR-DC or NE-DC for the UE 901 may follow the above-described embodiment.

In step 925, an OAM 907 may provide QoE measurement configuration information to the SN 905 to activate QoE measurement. The QoE measurement configuration information may include at least one of a service type (serviceType) on which QoE measurement is to be performed, management collection entity (MCE) IP Address, QoE configuration information (measConfigAppLayerContainer), and QoE reference. For reference, the above-described information may be in one or more pieces.

In step 930, the SN 905 may deliver at least one of the QoE measurement configuration information received from the OAM 907 to the MN 904. The SN 905 delivers measConfigAppLayerId mapped to each measReportAppLayerContainer to the MN 904. This is to prevent the same measConfigAppLayerId from being assigned to the UE AS 902 when the MN 904 receives QoE measurement configurations from the OAM 907 in the future. When the same measConfigAppLayerId is assigned to the UE AS 902, even if the MN 904 or SN 905 receives a QoE report from the UE AS 902, it cannot be determined to which QoE reference or MCE IP Address the measConfigAppLayerId is mapped since it may not be properly delivered to a final destination (TCE or MCE) 908. Accordingly, the SN 905 may deliver at least one of serviceType, MCE IP Address, QoE reference, and measConfigAppLayerContainer mapped to each measConfigAppLayerId to the MN 904 along with measConfigAppLayerId.

The SN 905 may inform the MN 904 of an explicit information element or without a separate indicator that the UE AS 902 reports a QoE report to the SN 905. Alternatively, it is indicated for each measConfigAppLayerId that a reporting leg is changed from the SN 905 to the MN 904 (or from the MN 904 to the SN 905), so the UE may transmit MeasReportAppLayer to the MN 904 and SN 905 accordingly.

As an example, when a specific measConfigAppLayerId is configured to be reported to the MN 904, the UE may transmit to the MN 904, the QoE measurement result for measConfigAppLayerId, which is configured to be reported to the MN. When other specific MeasConfigAppLayerId is configured to be reported to the SN 905, the UE may transmit to the SN 905, the QoE measurement results for measConfigAppLayerId, which is configured to be reported to the SN. The SN 905 may configure to the UE to report the QoE report (i.e., MeasReportAppLayer) to the MN 904, so the SN 905 may need to deliver the above information to the MN 904.

In step 935, the MN 904 may embed the QoE measurement configuration information (AppLayerMeasConfig) in a predetermined RRC message (e.g., RRCReconfiguration or RRCResume) through SRB 1 based on the information received from the SN and directly transmit the same to the UE AS 902. The UE AS 902 may identify whether the SN 905 has provided the QoE measurement configuration information through the predetermined RRC message. Through the predetermined RRC message, the UE may be configured to report the QoE report (i.e., MeasReportAppLayer) to the MN 904 or SN 905, as in the above-described embodiment.

Alternatively, without performing step 935 through step 937, the SN 905 may embed AppLayerMeasConfig in a predetermined RRC message (e.g., RRCReconfiguration) through SRB3 and transmit the same to the UE AS 902. Through the predetermined RRC message, the UE may be configured to report the QoE report (i.e., MeasReportAppLayer) to the MN 904 or SN 905, as in the above-described embodiment.

In step 940, the UE AS 902 may deliver all or some of the AppLayerMeasConfig received from the MN 904 or SN 905 through the AT command to the UE APP 903.

In step 945, the UE APP 903 may perform QoE measurement according to the configuration information received in step 940 and report the QoE measurement result to the UE AS 902 through the AT command according to the configuration information.

In step 950, when the UE AS is configured to report the QoE measurement results to the MN, the UE AS 902 configured to report the QoE measurement results to the MN 904 may report the measurement result to the MN 904 through a predetermined RRC message (e.g., MeasReportAppLayer) based on the information received in step 945. The UE AS 902 may use SRB4 to report the QoE measurement results. The information included in the predetermined RRC message and the procedure for transmitting the information may be as in the above-described embodiment.

In step 955, the MN 904 may deliver the measurement result information received in step 950 to the final destination (TCE or MCE) 908.

Alternatively, in step 960, without performing step 955, the MN 904 may deliver the measurement result information received in step 950 to the SN 905, and in step 965 the SN 905 may also deliver the information directly to the final destination (TCE or MCE) 908.

Alternatively, in step 970, when the UE AS is configured to report the QoE measurement results to the SN, the UE AS 902 configured to report the QoE measurement results to the SN 905 may directly report the measurement results to the SN 905 through a predetermined RRC message (e.g., MeasReportAppLayer) based on the information received in step 945. For example, the AS UE does not perform step 950, but in step 970, may directly report the QoE measurement results to the SN 905 through a predetermined RRC message (e.g., MeasReportAppLayer) based on the information received in step 945. In this case, at least one of split SRB4, new SRB (SRB5), split new SRB, SRB2, and SRB3 may be used to report the QoE measurement results. In step 975m the SN 905 may directly deliver the received information to the final destination (TCE or MCE) 908. For reference, when step 970 is performed, steps 955, 960, and 965 may be omitted.

When the UE AS 902 is configured to transmit a MeasReportAppLayer message to the MN 904, the MN 905 may configure the UE to transmit to the SN 905 through a predetermined RRC message (e.g., RRCReconfiguration or AppLayerMeasConfig), as described in the described embodiments above. For reference, this may be configured for each MeasConfigAppLayerId.

When the UE AS 902 is configured to transmit a MeasReportAppLayer message to the SN 905, the SN 905 may configure the UE to transmit to the MN 904 through a predetermined RRC message (e.g., RRCReconfiguration or AppLayerMeasConfig). For example, the predetermined RRC message may refer to an RRC connection reconfiguration message (RRCReconfiguration message) or RRC connection resumption message (RRCResume message).

Apparently, by indicating to change reporting leg from the SN to MN for each measConfigAppLayerId, the UE may transmit MeasReportAppLayer to the MN and SN accordingly. That is, when the UE is configured to report a specific measConfigAppLayerId to the MN, the UE may transmit, to the MN, the QoE measurement results for measConfigAppLayerId, which is configured to be reported to the MN. When another specific MeasConfigAppLayerId is configured to report to the SN, the UE may transmit, to the SN, the QoE measurement results for measConfigAppLayerId, which is configured to be reported to the SN.

Disclosed is a method for coordination for each node so that the measConfigAppLayerId assigned to the UE does not have the same value for all MNs and SNs or all cell groups (that is, measConfigAppLayerId is unique across the cell groups). Disclosed is a method in which the UE configured to report MeasReportAppLayer to the MN reports the MeasReportAppLayer to the SN (a method in which the UE configured to report MeasReportAppLayer to the SN reports the MeasReportAppLayer to the MN) when congestion occurs in the MN or SN and signaling procedures and necessary elements of the MN and SN accordingly.

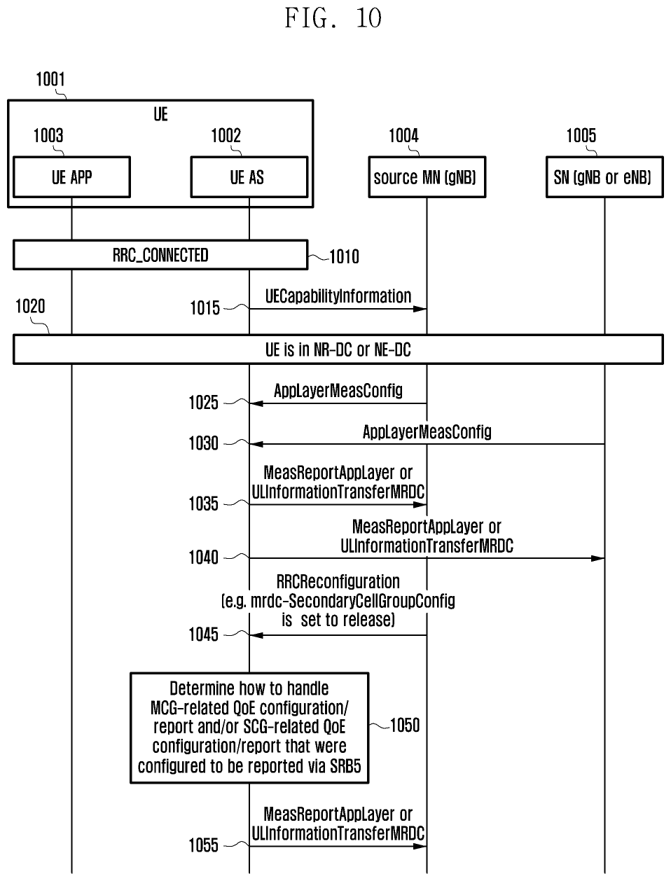

FIG. 10 illustrates a method for handling QoE configuration information and QoE measurement results related thereto when the UE with DC configured releases an SCG according to an embodiment.

Referring to FIG. 10, a procedure is illustrated for handling QoE configuration information and QoE measurement results related thereto when the UE configured with NR-DC or NE-DC releases an SCG.

Both a UE AS 1002 and a UE APP 1003 may be collectively referred to as a UE 1001. The base station 1004 may be referred to as an MN.

In step 1010, the UE 1001 may establish an RRC connection with the base station 1004 and be in the RRC connected mode (RRC_CONNECTED).

In step 1015, the UE AS 1002 may transmit a UE capability information message (e.g., UECapabilityInformation) to the base station 1004. The information embedded in the message may be as in the above-described embodiment.

In step 1020, the UE 1001 may be configured for NR-DC or NE-DC. The UE in NR-DC or NE-DC may transmit and receive data from the MN 1004 and SN 1005. Configuring NR-DC or NE-DC for the UE may be performed as in the above-described embodiment.

In step 1025, the UE AS 1002 may receive a predetermined RRC message (e.g., RRCReconfiguration or RRCResume) embedding QoE measurement configuration information (AppLayerMeasConfig) from the MN 1004. The AppLayerMeasConfig may include QoE measurement configuration information associated with an MCG and/or QoE measurement configuration information associated with an SCG.

Through the RRC message, the UE 1002 may be configured to report a QoE report to the MN 1004 or SN 1005 for each measConfigAppLayerId for each QoE configuration. That is, the UE 1002 may be configured to report a QoE report for each measConfigAppLayerId configured in association with the MN 1004 to the MN 1004 or SN 1005 or may be configured to report a QoE report for each measConfigAppLayerId configured in association with the SN 1005 to the MN 1004 or SN 1005. The UE 1002 may be configured to report the entire QoE configurations configured in association with the MN 1004 to the MN 1004 or SN 1005, and/or may be configured to report the entire QoE configurations configured in association with the SN 1005 to the MN 1004 or SN 1005.

In step 1030, the UE AS 1002 may receive a predetermined RRC message (e.g., RRCReconfiguration) embedding QoE measurement configuration information (AppLayerMeasConfig) from the SN 1005. The AppLayerMeasConfig may include the QoE measurement configuration information associated with an MCG and/or QoE measurement configuration information associated with an SCG. Specific procedures may be as in the above-described embodiments.

Through the RRC message, the UE 1002 may be configured to report a QoE report to the MN 1004 or SN 1005 for each measConfigAppLayerId (i.e., for each QoE configuration). That is, the UE 1002 may be configured to report a QoE report for each measConfigAppLayerId configured in association with the MN 1004 to the MN 1004 or SN 1005 or may be configured to report a QoE report for each measConfigAppLayerId configured in association with the SN 1005 to the MN 1004 or SN 1005. The UE 1002 may be configured to report the entire QoE configurations configured in association with the MN 1004 to the MN 1004 or SN 1005, and/or may be configured to report the entire QoE configurations configured in association with the SN 1005 to the MN 1004 or SN 1005.

Steps 1025 and 1030 may both be performed, or only step 1025 may be performed with step 1030 being omitted.

In step 1035, the UE AS 1002 may transmit a MeasReportAppLayer message including the QoE measurement results to the MN 1004 through SRB4. The QoE measurement result may refer to the QoE reports for QoE configuration information(s) associated with the MCG and/or QoE reports for QoE configuration information(s) associated with the SCG, configured to be transmitted to the MN 1004.

The UE may transmit, to the MN 1004, a ULInformationTransferMRDC message embedding the QoE reports for the QoE configuration information(s) associated with the SCG configured to be transmitted to MN 1004, through SRB4. That is, the UE may embed the QoE reports about the QoE configuration information(s) associated with the SCG configured to be transmitted to the MN 1004 in the MeasReportAppLayer message, or in a separate ULInformationTransferMRDC message. Alternatively, the UE may include the QoE reports in a separate ULInformationTransferMRDC message and the ULInformationTransferMRDC message may be embedded in the MeasReportAppLayer message and transmitted.

In step 1040, the terminal AS 1002 may transmit a MeasReportAppLayer message including the QoE measurement results to the SN 1005 through SRB5. The QoE measurement result may refer to the QoE reports for QoE configuration information(s) associated with the MCG and/or QoE reports for QoE configuration information(s) associated with the SCG, configured to be transmitted to the SN 1005.

The UE may transmit, to the SN 1005, a ULInformationTransferMRDC message embedding the QoE reports for the QoE configuration information(s) associated with the MCG configured to be transmitted to SN 1005, through SRB5. That is, the UE may embed the QoE reports about the QoE configuration information(s) associated with the MCG configured to be transmitted to the SN 1005 in the MeasReportAppLayer message, or in a separate ULInformationTransferMRDC message. Alternatively, the UE may include the QoE reports in a separate ULInformationTransferMRDC message and the ULInformationTransferMRDC message may be embedded in the MeasReportAppLayer message and transmitted.

In step 1045, the MN 1004 may transmit a predetermined RRC message (e.g., RRCReconfiguration) to release the SN or SCG 1005 configured to the UE 1001. As an example, SCG may be released through mrdc-SecondaryCellGroupConfig.

In step 1050, the UE 1001 determines the manner in which to handle a QoE configuration report that was configured to be reported via SRB5. In this regard, at least one of the following methods may be combined and performed.

Method 1: When releasing the SCG, the UE 1001 may release the QoE configuration information associated with the SCG 1005 and the QoE measurement results associated therewith without a separate base station indication.

Method 2: When releasing the SCG, the UE 1001 may release the QoE configuration information associated with the SCG configured to report the QoE measurement results to the SN 1005 (i.e., via SRB5) and the QoE measurement results for this, without a separate base station indication.

In Method 2, the QoE configuration associated with the SCG configured to report the QoE measurement results to the MN 1004 and the associated QoE measurement results are not released. Specifically, even if the MN 1004 receives the QoE measurement results from the UE 1001, the MN 1004 may deliver the QoE measurement results to the TCE or SN.

Method 3: When releasing the SCG, the UE 1001 may release the QoE configuration information associated with the SCG 1005 and the QoE measurement results associated therewith according to the base station indication. For example, in step 1045, the MN 1004 may indicate the UE 1001 whether to release the QoE configuration information associated with the SCG 1005 and the QoE measurement results associated therewith. Accordingly, the UE 1001 may determine whether to release the QoE configuration information associated with the SCG 1005 and the QoE measurement result associated therewith.

Method 4: When releasing the SCG, the UE 1001 may release each QoE configuration information associated with the SCG 1005 and the QoE measurement results associated therewith, according to the base station indication.

In Method 4, the base station is enabled to indicate the UE whether to release the QoE configuration information for each measConfigAppLayerId associated with the SCG, and QoE measurement results.

Method 5: When releasing the SCG, the UE 1001 may maintain the QoE configuration information associated with the MCG configured to be transmitted to the SN 1005 without a separate base station indication and transmit the QoE reports for this to the MN 1004 through SRB4.

Method 6: When releasing the SCG, the UE 1001 may maintain the QoE configuration information associated with the MCG configured to be transmitted to the SN 1005 according to the base station indication and determine whether to transmit the QoE reports for this to the MN 1004 through SRB4.

In Method 6, the base station indication may be applied for each QoE configuration associated with the MCG. That is, when the base station indicates to transmit to the MN for a specific QoE configuration, the UE may transmit corresponding QoE reports to the MN 1004. In this case, for QoE configurations for which there was no separate indication, the UE may release the QoE configurations together with the QoE report or maintain the QoE configurations (it is because that the UE may later transmit the corresponding QoE report to the MN according to the base station indication).

When the UE 1001 releases a specific QoE configuration, information about this may be notified to the UE APP 1003. Thus, the UE APP 1003 may no longer perform the QoE measurement for the corresponding QoE configurations.

In step 1055, the UE AS 1002 may transmit a MeasReportAppLayer message or ULInformationTransferMRDC message including the QoE measurement result to the MN 1004 through SRB4, as in step 1035.

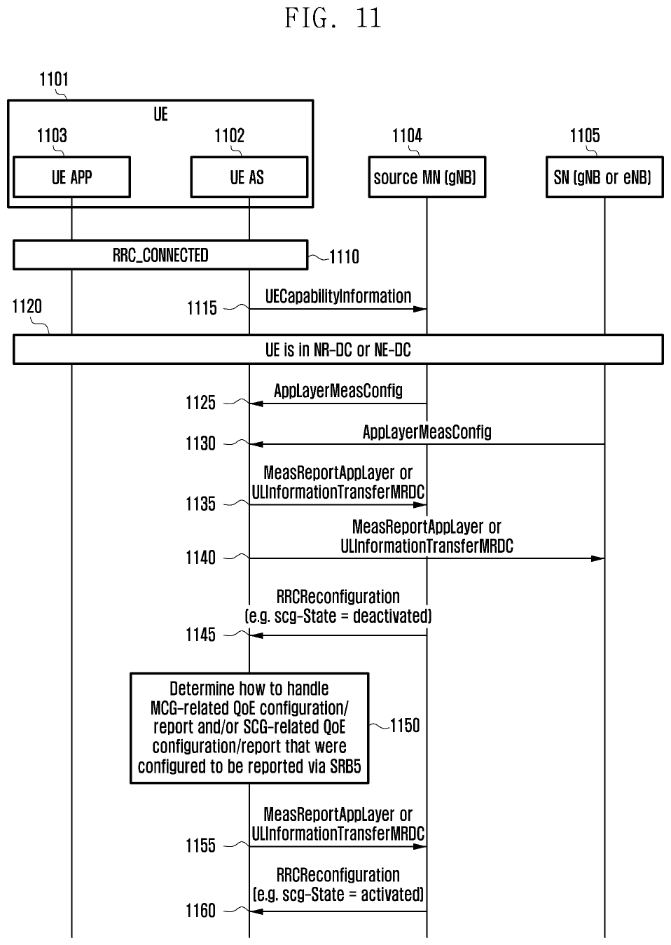

FIG. 11 illustrates a method for handling QoE configuration information and QoE measurement results related thereto when the UE with DC configured deactivates an SCG according to an embodiment.

Referring to FIG. 11, a procedure is illustrated for handling QoE configuration information and QoE measurement results related thereto when the UE configured with NR-DC or NE-DC deactivates an SCG.

Both a UE AS 1102 and a UE application layer (APP) 1103 may be collectively referred to as a UE 1101. The base station 1104 may be referred to as an MN.

In step 1110, the UE 1101 may establish an RRC connection with the base station 1104 and be in the RRC connected mode (RRC_CONNECTED). In step 1115, the UE AS 1102 may transmit a UE capability information message n (e.g., UECapabilityInformation) to the base station 1104. The information embedded in the message may be as in the above-described embodiment.

In step 1120, the UE 1101 may be configured for NR-DC or NE-DC. The UE 1101 in NR-DC or NE-DC may transmit and receive data from the MN 1104 and SN 1105, as in the above-described embodiment.

In step 1125, the UE AS 1102 may receive a predetermined RRC message (e.g., RRCReconfiguration or RRCResume) embedding QoE measurement configuration information (AppLayerMeasConfig) from the MN 1104. The AppLayerMeasConfig may include QoE measurement configuration information associated with an MCG and/or QoE measurement configuration information associated with an SCG, as in the above-described embodiments.

Through the RRC message, the UE 1102 may be configured to report a QoE report to the MN 1104 or SN 1105 for each measConfigAppLayerId (i.e., for each QoE configuration). That is, the UE 1102 may be configured to report a QoE report for each measConfigAppLayerId configured in association with the MN 1104 to the MN 1104 or SN 1105, or may be configured to report a QoE report for each measConfigAppLayerId configured in association with the SN 1105 to the MN 1104 or SN 1105. The UE 1102 may be configured to report the entire QoE configurations configured in association with the MN 1104 to the MN 1104 or SN 1105, and/or may be configured to report the entire QoE configurations configured in association with the SN 1105 to the MN 1104 or SN 1105.

In step 1130, the UE AS 1102 may receive a predetermined RRC message (e.g., RRCReconfiguration) embedding QoE measurement configuration information (AppLayerMeasConfig) from the SN 1105. The AppLayerMeasConfig may include the QoE measurement configuration information associated with an MCG and/or QoE measurement configuration information associated with an SCG, as in the above-described embodiments.

Through the RRC message, the UE 1102 may be configured to report a QoE report to the MN 1104 or SN 1105 for each measConfigAppLayerId (i.e., for each QoE configuration). That is, the UE 1102 may be configured to report a QoE report for each measConfigAppLayerId configured in association with the MN 1104 to the MN 1104 or SN 1105 or may be configured to report a QoE report for each measConfigAppLayerId configured in association with the SN 1105 to the MN 1104 or SN 1105. The UE 1102 may be configured to report the entire QoE configurations configured in association with the MN 1104 to the MN 1104 or SN 1105, and/or may be configured to report the entire QoE configurations configured in association with the SN 1105 to the MN 1104 or SN 1105.

Both of steps 1125 and 1130 may be performed, or only step 1125 may be performed with 1130 being omitted.

In step 1135, the UE AS 1102 may transmit a MeasReportAppLayer message including the QoE measurement results to the MN 1104 through SRB4. The QoE measurement result may refer to the QoE reports for QoE configuration information(s) associated with the MCG and/or QoE reports for QoE configuration information(s) associated with the SCG, configured to be transmitted to the MN 1104.

The UE may transmit, to the MN 1104, a ULInformationTransferMRDC message embedding the QoE reports for the QoE configuration information(s) associated with the SCG configured to be transmitted to MN 1104, through SRB4. That is, the UE may embed the QoE reports about the QoE configuration information(s) associated with the SCG configured to be transmitted to the MN 1104 in the MeasReportAppLayer message, or in a separate ULInformationTransferMRDC message.

In step 1140, the terminal AS 1102 may transmit a MeasReportAppLayer message including the QoE measurement results to the SN 1105 through SRB5. The QoE measurement result may refer to the QoE reports for QoE configuration information(s) associated with the MCG and/or QoE reports for QoE configuration information(s) associated with the SCG, configured to be transmitted to the SN 1105.

The UE may transmit to the SN 1105, a ULInformationTransferMRDC message embedding the QoE reports for the QoE configuration information(s) associated with the MCG configured to be transmitted to SN 1105, through SRB5. That is, the UE may embed the QoE reports about the QoE configuration information(s) associated with the MCG configured to be transmitted to the SN 1105 in the MeasReportAppLayer message, or in a separate ULInformationTransferMRDC message.

In step 1145, the MN 1104 may transmit a predetermined RRC message (e.g., RRCReconfiguration) to deactivate the SN or SCG 1105 configured to the UE 1101. As an example, SCG may be deactivated through scg-State.

In step 1150, the UE 1101 according to the disclosure may perform at least one of the methods proposed below. That is, the following methods may be combined and performed, and only one method may be performed.

Method 7: When deactivating the SCG, the UE 1101 may transmit all QoE measurement results that have been configured to be transmitted to the SN 1105 through SRB5 to the MN 1104 through SRB4, without a separate base station indication.

Method 8: When deactivating the SCG, the UE 1101 may transmit all QoE measurement results that have been configured to be transmitted to the SN 1105 through SRB5 to the MN 1104 through SRB4, according to the base station indication. The base station indication may be performed through the 1145 operation, the previous operation (1125 or 1130), or a later RRCReconfiguration message.

Method 9: When deactivating the SCG, the base station may indicate the UE to transmit, to the MN 1104, the QoE measurement results for some of the QoE configuration information that has been configured to be transmitted to the SN 1105 through SRB5, through SRB4. That is, the UE may be indicated to transmit the QoE measurement results for each measConfigAppLayerId to the MN 1104 through SRB4. The base station indication may be performed through step 1145, the previous operation (1125 or 1130), or a later RRCReconfiguration message.

In step 1155, the UE AS 1102 may transmit a MeasReportAppLayer message or ULInformationTransferMRDC message including the QoE measurement results to the MN 1104 through SRB4. This may be as in step 1135.

In step 1160, the MN 1104 may transmit a predetermined RRC message (e.g., RRCReconfiguration) to activate the SN or SCG 1105 configured to the UE 1101. As an example, the SCG may be activated by not including scg-State in the RRC message. When activating the SCG, the UE 1101 according to the disclosure may perform at least one of the methods proposed below. That is, the following methods may be combined and performed, or only one method may be performed.

Method 10: When activating the SCG, the UE 1101 may retransmit, to the SN 1105, all QoE measurement results that have been configured to be transmitted to the SN 1105 through SRB5 (prior to step 1160), through SRB5, without a separate base station indication.

Method 11: When activating the SCG, the UE 1101 may retransmit, to the SN 1105, all QoE measurement results that have been configured to be transmitted to the SN 1105 through SRB5 (prior to step 1160), through SRB5, according to a base station indication.

The base station may indicate the UE to retransmit the QoE measurement results for each QoE configuration to the SN 1105 through SRB5.

Method 12: When the UE 1101 transmits all QoE measurement results that have been configured to be transmitted to the SN 1105 through SRB5 before SCG deactivation, to the MN 1104 through SRB4 during the SCG deactivation period, the UE 1101 may retransmit the corresponding QoE measurement results to the SN 1105 through SRB5 without a separate base station indication.

Method 13: When the UE 1101 transmits all QoE measurement results that have been configured to be transmitted to the SN 1105 through SRB5 before SCG deactivation, to the MN 1104 through SRB4 during the SCG deactivation period, the UE 1101 may retransmit the corresponding QoE measurement results to the SN 1105 through SRB5 according to a base station indication.

The base station may indicate the UE to retransmit the QoE measurement results for each QoE configuration to the SN 1105 through SRB5.

Method 14: When before deactivating the SCG, the base station indicates the UE to transmit the QoE measurement results for some QoE configuration information among the QoE configuration information that has been configured to be transmitted to the SN 1105 through SRB5 to the MN 1104 through SRB4, the UE 1101 may retransmit the corresponding QoE measurement results to the SN 1105 through SRB5 according to the base station indication.

The base station may indicate the UE to retransmit the QoE measurement results for each QoE configuration to the SN 1105 through SRB5.

The UE may apply at least one of the methods proposed above to the QoE measurement results for QoE configurations that were not transmitted to the MN 1104 through SRB4.

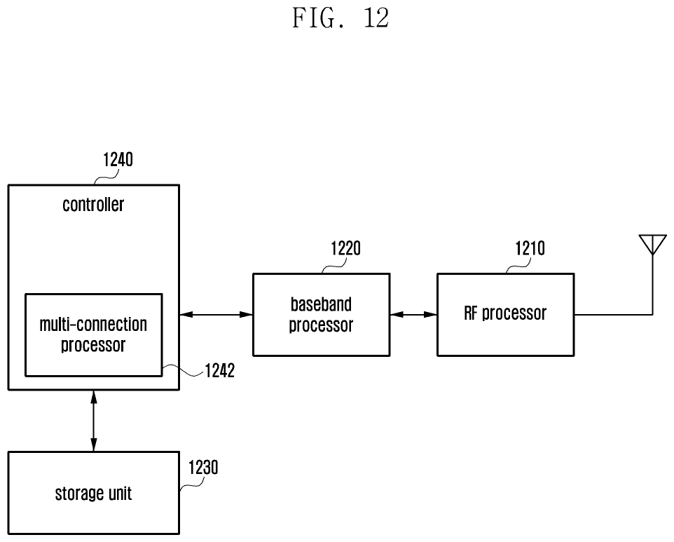

FIG. 12 illustrates an internal structure of the UE according to an embodiment.

Referring to FIG. 12, the UE may include a radio frequency (RF) processor 1210, a baseband processor 1220, a storage unit 1230, and a controller 1240.

The RF processor 1210 may perform a function for transmitting and receiving a signal through a wireless channel, such as band conversion and amplification of a signal. That is, the RF processor 1210 may up-convert a baseband signal provided from the baseband processor 1220 into an RF band signal, transmit the RF band signal through an antenna, and then down-convert the RF band signal received through the antenna into a baseband signal. For example, the RF processor 1210 may include a transmission filter, a reception filter, an amplifier, a mixer, an oscillator, a digital-to-analog converter (DAC), an analog-to-digital converter (ADC), and the like. Although the drawing illustrates only one antenna, the UE may include a plurality of antennas. The RF processor 1210 may include a plurality of RF chains. Moreover, the RF processor 1210 may perform beamforming. For the beamforming, the RF processor 1210 may control a phase and a size of each signal transmitted/received through a plurality of antennas or antenna elements. The RF processor may perform MIMO and receive a plurality of layers when performing the MIMO operation.

The baseband processor 1220 may perform a function for a conversion between a baseband signal and a bitstream according to a physical layer standard of the system. For example, when data is transmitted, the baseband processor 1220 may generate complex symbols by encoding and modulating a transmission bitstream. Further, when data is received, the baseband processor 1220 may reconstruct a reception bitstream by demodulating and decoding a baseband signal provided from the RF processor 1210. For example, in an OFDM scheme, when data is transmitted, the baseband processor 1220 may generate complex symbols by encoding and modulating a transmission bitstream, mapping the complex symbols to subcarriers, and then configure OFDM symbols through an inverse fast Fourier transform (IFFT) operation and a cyclic prefix (CP) insertion. Further, when data is received, the baseband processor 1220 may divide the baseband signal provided from the RF processor 1210 in the unit of OFDM symbols, reconstruct the signals mapped to the subcarriers through an FFT operation, and then reconstruct a reception bitstream through demodulation and decoding.

The baseband processor 1220 and the RF processor 1210 may transmit and receive signals as described above. Accordingly, the baseband processor 1220 and the RF processor 1210 may be referred to as a transmitter, a receiver, a transceiver, or a communication unit. Further, at least one of the baseband processor 1220 and the RF processor 1210 may include a plurality of communication modules to support a plurality of different radio access technologies. In addition, at least one of the baseband processor 1220 and the RF processor 1210 may include different communication modules to process signals of different frequency bands. For example, the different radio-access technologies may include wireless LAN (e.g., IEEE 802.11), cellular network (e.g., LTE), etc. The different frequency bands may include a super high frequency (SHF) band and a millimeter (mm) wave (for example, 60 GHz) band.

The storage unit 1230 stores data such as basic program, an application, and setting information for the operation of the UE. In particular, the storage unit 1230 may store information related to a second access node that performs wireless communication using a second wireless access technology. The storage unit 1230 may provide stored data according to the request of the controller 1240.

The controller 1240 may control the overall operation of the UE. For example, the controller 1240 may transmit/receive a signal through the baseband processor 1220 and the RF processor 1210. The controller 1240 may record data in the storage unit 1230 and read the data. To this end, the controller 1240 may include at least one processor. For example, the controller 1240 may include a communication processor that performs a control for communication, and an application processor (AP) that controls a higher layer such as an application program. The controller 1240 may further include a multi-connection processor 1242 to support multiple connections. The controller 1240 may control the operation of the UE according to various embodiments of the disclosure. The controller 1240 may control the operations of the UE AS and UE APP according to various embodiments.

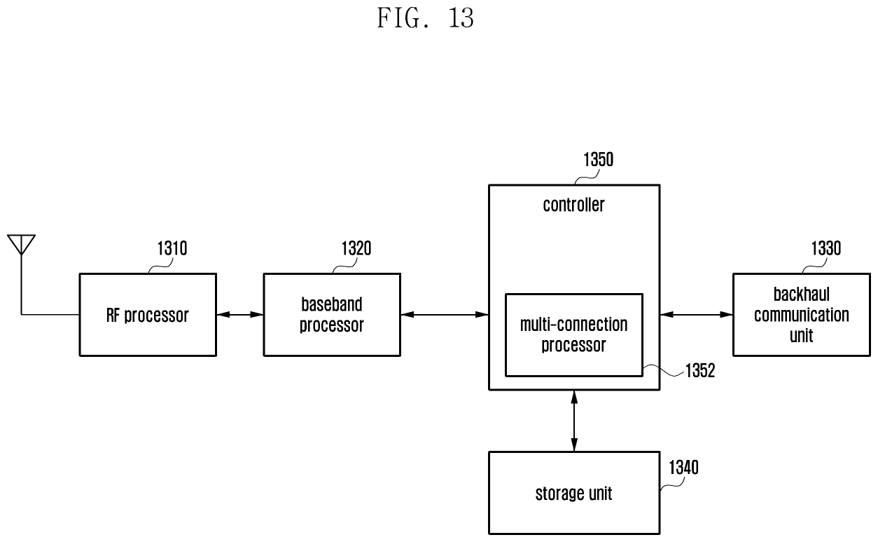

FIG. 13 illustrates a structure of the NR base station according to an embodiment.

Referring to FIG. 13, the base station may include an RF processor 1310, a baseband processor 1320, a backhaul communication unit 1330, a storage 1340, and a controller 1350.

The RF processor 1310 may perform a function for transmitting and receiving a signal through a wireless channel, such as band conversion and amplification of a signal. That is, the RF processor 1310 may up-convert a baseband signal provided from the baseband processor 1320 into an RF band signal and then transmit the converted signal through an antenna, and down-convert an RF band signal received through the antenna into a baseband signal. For example, the RF processor 1310 may include a transmission filter, a reception filter, an amplifier, a mixer, an oscillator, a DAC, an ADC, and the like. Although the drawing illustrates only one antenna, the first access node may include a plurality of antennas. The RF processor 1310 may include a plurality of RF chains. Moreover, the RF processor 1310 may perform beamforming. For the beamforming, the RF processor 1310 may control a phase and a size of each of the signals transmitted and received through a plurality of antennas or antenna elements. The RF processor may perform a downlink MIMO operation by transmitting one or more layers.

The baseband processor 1320 may perform a function of performing conversion between a baseband signal and a bitstream according to a physical layer standard of the first radio access technology. For example, when data is transmitted, the baseband processor 1320 may generate complex symbols by encoding and modulating a transmission bitstream. Further, when data is received, the baseband processor 1320 may reconstruct a reception bitstream by demodulating and decoding a baseband signal provided from the RF processor 1310. For example, in an OFDM scheme, when data is transmitted, the baseband processor 1320 may generate complex symbols by encoding and modulating the transmission bitstream, map the complex symbols to subcarriers, and then configure OFDM symbols through an IFFT operation and CP insertion. In addition, when data is received, the baseband processor 1320 may divide a baseband signal provided from the RF processor 1310 in units of OFDM symbols, recover signals mapped with sub-carriers through an FFT operation, and then recover a reception bitstream through demodulation and decoding. The baseband processor 1320 and the RF processor 1310 may transmit and receive signals as described above. Accordingly, the baseband processor 1320 and the RF processor 1310 may be referred to as a transmitter, a receiver, a transceiver, a communication unit or a wireless communication unit.

The backhaul communication unit 1330 may provide an interface for communicating with other nodes within the network. That is, the backhaul communication unit 1330 may convert a bit string transmitted from the main base station to another node, for example, an auxiliary base station, a core network, etc., into a physical signal, and convert the physical signal received from the other node into a bit string.

The storage unit 1340 may store data such as a basic program, an application, and configuration information for the operation of the main base station. Particularly, the storage unit 1340 may store information on bearers allocated to the accessed UE, the measurement result reported from the accessed UE, and the like. The storage unit 1340 may store information on a reference for determining whether to provide multiple connections to the UE or stop the multiple connections. The storage unit 1340 may provide data stored therein according to a request from the controller 1350.

The controller 1350 may control the overall operation of the main base station. For example, the controller 1350 may transmit and receive a signal through the baseband processor 1320 and the RF processor 1310 or through the backhaul communication unit 1330. The controller 1350 may record data in the storage unit 1340 and read the data. To this end, the controller 1350 may include at least one processor. The controller 1350 may further include a multi-connection processor 1342 to support multiple connections. The controller 1350 may control the operation of the base station and/or the operation of the NG-RAN according to various embodiments of the disclosure.

Methods disclosed herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. A plurality of such memories may be included.

The programs may be stored in an attachable storage device which may access through communication networks such as the Internet, Intranet, local area network (LAN), Wide LAN (WLAN), and storage area network (SAN) or a combination thereof. Such a storage device may access the apparatus performing the embodiments of the disclosure via an external port. Further, a separate storage device on the communication network may access the apparatus performing the embodiments of the disclosure.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) supporting a master cell group (MCG) and a secondary cell group (SCG) in a wireless communication system, the method comprising:
receiving at least one application layer measurement configuration information included in a first radio resource control (RRC) reconfiguration information for the MCG or included in a second RRC reconfiguration information for the SCG;
based on the at least one application layer measurement configuration information, transmitting a report message for an application layer measurement report;
receiving a second RRC reconfiguration message for releasing the SCG;
informing, for first application layer measurement configuration information included in the second RRC reconfiguration information for the SCG, an upper layer about a release of the first application layer measurement configuration information; and
discarding a first application layer measurement report associated with the first application layer measurement configuration information that is not yet fully submitted to a lower layer for a transmission.

2. The method of claim 1, further comprising:
discarding, for second application layer measurement configuration information included in the first RRC reconfiguration information for the MCG, a second application layer measurement report associated with the second application layer measurement configuration information which are configured to report via a signaling radio bearer 5 (SRB 5) and which are not yet fully submitted to lower layers for a transmission.

3. The method of claim 2, further comprising:
receiving a third RRC message including configuration information indicating the second application layer measurement report to report via a signaling radio bearer 4 (SRB 4); and
based on the configuration information, transmitting the second application layer measurement via the SRB 4.

4. The method of claim 3, further comprising:
in case that the second application layer measurement configuration information is included in the RRC reconfiguration information for the MCG, changing an SRB for the second application layer measurement report from the SRB5 to the SRB4, and
reporting the second application layer measurement report via the SRB4.

5. The method of claim 1,
wherein the at least one application layer measurement is associated with a quality of experience (QoE).

6. The method of claim 5, further comprising:
transmitting a UE capability information message including at least one first information on a QoE streaming measurement report, second information on a QoE multimedia telephony service for an international mobile subscriber identity measurement report, and third information on a QoE virtual reality measurement report.

7. A method performed by a base station associated with a master cell group (MCG) in a wireless communication system, the method comprising:
transmitting, to a user equipment (UE), at least one application layer measurement configuration information included in a first radio resource control (RRC) reconfiguration information for the MCG or included in a second RRC reconfiguration information for a secondary cell group (SCG); and
transmitting, to the UE, a second RRC reconfiguration message for releasing the SCG,
wherein for first application layer measurement configuration information included in the second RRC reconfiguration information for the SCG, a release of the first application layer measurement configuration information is informed to an upper layer, and
wherein a first application layer measurement report associated with the first application layer measurement configuration information which is not yet fully submitted to a lower layer for a transmission is discarded.

8. The method of claim 7,
wherein for second application layer measurement configuration information included in the RRC reconfiguration information for the MCG, a second application layer measurement report associated with the second application layer measurement configuration information which is configured to report via a signaling radio bearer 5 (SRB 5) and which is not yet fully submitted to lower layers for a transmission is discarded.

9. The method of claim 8, further comprising:
transmitting, to the UE, a third RRC message including configuration information indicating the second application layer measurement report to report via a signaling radio bearer (SRB 4); and
based on the configuration information, receiving, from the UE, the second application layer measurement via the SRB 4.

10. The method of claim 7, further comprising:
receiving, from the UE, a UE capability information message including at least one first information on a quality of experience (QoE) streaming measurement report, second information on a QoE multimedia telephony service for an international mobile subscriber identity measurement report, and third information on a QoE virtual reality measurement report,
wherein the at least one application layer measurement is associated with the QoE.

11. A user equipment (UE) supporting a master cell group (MCG) and a secondary cell group (SCG) in a wireless communication system, the UE comprising:
a transceiver; and
a controller configured to:
receive at least one application layer measurement configuration information included in a first radio resource control (RRC) reconfiguration information for the MCG or included in a second RRC reconfiguration information for the SCG,
based on the at least one application layer measurement configuration information, transmit a report message for an application layer measurement report,
receive a second RRC reconfiguration message for releasing the SCG,
inform, for first application layer measurement configuration information included in the second RRC reconfiguration information for the SCG, an upper layer about a release of the first application layer measurement configuration information, and
discard a first application layer measurement report associated with the first application layer measurement configuration information which is not yet fully submitted to a lower layer for a transmission.

12. The UE of claim 11, wherein the controller is further configured to:
discard, for second application layer measurement configuration information included in the first RRC reconfiguration information for the MCG, a second application layer measurement report associated with the second application layer measurement configuration information which is configured to report via a signaling radio bearer 5 (SRB 5) and which is not yet fully submitted to lower layers for a transmission.

13. The UE of claim 12, wherein the controller is further configured to:
receive a third RRC message including configuration information indicating the second application layer measurement report to report via a signaling radio bearer 4 (SRB 4), and
based on the configuration information, transmit the second application layer measurement via the SRB 4.

14. The UE of claim 13, wherein the controller is further configured to:
in case that the second application layer measurement configuration information is included in the RRC reconfiguration information for the MCG, change an SRB for the second application layer measurement report from the SRB5 to the SRB4, and
report the second application layer measurement report via the SRB4.

15. The UE of claim 11,
wherein the at least one application layer measurement is associated with a quality of experience (QoE).

16. The UE of claim 15, wherein the controller is further configured to:
transmit a UE capability information message including at least one first information on a QoE streaming measurement report, second information on a QoE multimedia telephony service for an international mobile subscriber identity measurement report, and third information on a QoE virtual reality measurement report.

17. A base station associated with a master cell group (MCG) in a wireless communication system, the base station comprising:
a transceiver; and
a controller configured to:
transmit, to a user equipment, at least one application layer measurement configuration information included in a first radio resource control (RRC) reconfiguration information for the MCG or included in a second RRC reconfiguration information for a secondary cell group (SCG), and
transmit, to the UE, a second RRC reconfiguration message for releasing the SCG,
wherein for first application layer measurement configuration information included in the second RRC reconfiguration information for the SCG, a release of the first application layer measurement configuration information is informed to an upper layer, and
wherein a first application layer measurement report associated with the first application layer measurement configuration information which is not yet fully submitted to a lower layer for a transmission is discarded.

18. The base station of claim 17,
wherein for second application layer measurement configuration information included in the RRC reconfiguration information for the MCG, a second application layer measurement report associated with the second application layer measurement configuration information which is configured to report via a signaling radio bearer 5 (SRB 5) and which is not yet fully submitted to lower layers for a transmission is discarded.

19. The base station of claim 18, wherein the controller is further configured to:
transmit, to the UE, a third RRC message including configuration information indicating the second application layer measurement report to report via a signaling radio bearer (SRB 4), and
based on the configuration information, receive, from the UE, the second application layer measurement via the SRB 4.

20. The base station of claim 17, wherein the controller is further configured to:
receive, from the UE, a UE capability information message including at least one first information on a quality of experience (QoE) streaming measurement report, second information on a QoE multimedia telephony service for an international mobile subscriber identity measurement report, and third information on a QoE virtual reality measurement report,
wherein the at least one application layer measurement is associated with the QoE.
